(19) United States
(12) Patent Application Publication
(10) Pub. No.: US 2019/0123389 A1
(43) Pub. Date: Apr. 25, 2019

(54) LITHIUM ION SECONDARY BATTERY

(71) Applicant: THE UNIVERSITY OF TOKYO, Tokyo (JP)

(72) Inventors: Yoshihiro NAKAGAKI, Kariya-shi (JP); Tomoyuki KAWAI, Kariya-shi (JP); Hiroyuki SASAKI, Kariya-shi (JP)

(73) Assignee: THE UNIVERSITY OF TOKYO, Tokyo (JP)

(21) Appl. No.: 16/093,409

(22) PCT Filed: Mar. 28, 2017
(86) PCT No.: PCT/JP2017/012611

§ 371 Date: Oct. 12, 2018

(30) Foreign Application Priority Data
Apr. 15, 2016 (JP) 2016-081767

(51) Int. Cl. H01M 10/0568; H01M 10/0525; H01M 10/0569; H01M 4/04

(52) U.S. Cl. CPC H01M 10/0568; H01M 10/0525; H01M 2300/0028; H01M 4/0447; H01M 10/0569

(57) ABSTRACT

A lithium ion secondary battery having long life is provided.

A lithium ion secondary battery includes: an electrolytic solution containing (FSO₂)₂NLi and a linear carbonate represented by general formula (A) below; and a negative electrode having a negative electrode active material, wherein
materials having a long diameter of 30 nm or greater exist on a surface of the negative electrode active material in a range of not less than 0 counts/μm² and less than 80 counts/μm²,

R²⁰OCOOR²¹ general formula (A)
(R²⁰ and R²¹ are each independently selected from CₙHₐF_{b}Cl_{c}Br_{d}Iₑ that is a linear alkyl, or CₘH_{f}F_{g}ClₕBrᵢIⱼ that includes a cyclic alkyl in the chemical structure thereof. “n” is an integer not smaller than 1, “m” is an integer not smaller than 3, and “a”, “b”, “c”, “d”, “e”, “f ”, “g”, “h”, “i”, and “j” are each independently an integer not smaller than 0, and satisfy 2n+1=a+b+c+d+e and 2m−1=f+g+h+i+j.).

### TECHNICAL FIELD

The present invention relates to a lithium ion secondary battery.

### BACKGROUND ART

Generally, a power storage device such as a secondary battery includes, as main components, a positive electrode, a negative electrode, and an electrolytic solution. In the electrolytic solution, an appropriate electrolyte is added at an appropriate concentration range. For example, in an electrolytic solution of a lithium ion secondary battery, a lithium salt such as LiClO₄, LiAsF₆, LiPF₆, LiBF₄, CF₃SO₃Li, and (CF₃SO₂)₂NLi is commonly added as an electrolyte, and the concentration of the lithium salt in the electrolytic solution is generally set at approximately 1 mol/L.

In an organic solvent to be used in an electrolytic solution, an organic solvent having a high relative permittivity and a high dipole moment such as ethylene carbonate or propylene carbonate is generally mixed by approximately 30 vol % or greater, in order to suitably dissolve an electrolyte.

Actually, Patent Literature 1 discloses a lithium ion secondary battery using an electrolytic solution that uses a mixed organic solvent containing ethylene carbonate by 33 vol % and that contains LiPF₆ at a concentration of 1 mol/L. Moreover, Patent Literature 2 discloses a lithium ion secondary battery using an electrolytic solution that uses a mixed organic solvent containing ethylene carbonate and propylene carbonate by 66 vol % and that contains (CF₃SO₂)₂NLi at a concentration of 1 mol/L.

In addition, for the purpose of improving the performance of secondary batteries, studies have been actively conducted for various additives to be added to an electrolytic solution containing a lithium salt.

For example, Patent Literature 3 describes an electrolytic solution obtained by adding a small amount of a specific additive to an electrolytic solution that uses a mixed organic solvent containing ethylene carbonate by 30 vol % and that contains LiPF₆ at a concentration of 1 mol/L. Patent Literature 3 also discloses a lithium ion secondary battery using this electrolytic solution.

Furthermore, Patent Literature 4 describes an electrolytic solution obtained by adding a small amount of phenyl glycidyl ether to a solution that uses a mixed organic solvent containing ethylene carbonate by 30 vol % and that contains LiPF₆ at a concentration of 1 mol/L. Patent Literature 4 also discloses a lithium ion secondary battery using this electrolytic solution.

As described in Patent Literature 1 to 4, conventionally, in an electrolytic solution to be used in a lithium ion secondary battery, using a mixed organic solvent containing an organic solvent having a high relative permittivity and a high dipole moment, such as ethylene carbonate or propylene carbonate, by approximately 30 vol % or greater and containing a lithium salt at a concentration of approximately 1 mol/L were common technical knowledge. In addition, as described in Patent Literature 3 and 4, studies for improving electrolytic solutions have been generally conducted with a focus on additives, which are separate from the lithium salt.

Unlike the focus of a person skilled in the art hitherto, the present inventors have focused on and studied for an electrolytic solution that contains a metal salt at a high concentration and in which the metal salt and an organic solvent exist in a new state, and have reported the results in Patent Literature 5.

In addition, generally, a coating is known to form on the surfaces of the negative electrode and the positive electrode in a secondary battery. This coating is also called SEI (solid electrolyte interphase), and is formed from reductive degradation products, etc., of an electrolytic solution. For example, Patent Literature 6 describes an SEI coating.

The SEI coatings on the surfaces of the negative electrode and the positive electrode allow a charge carrier such as lithium ions to pass therethrough. Moreover, the SEI coating on the surface of the negative electrode is considered to exist between the surface of the negative electrode and the electrolytic solution and to suppress further reductive degradation of the electrolytic solution. The existence of the SEI coating is considered to be essential particularly for a low potential negative electrode using a graphite or Si-based negative electrode active material.

If continuous degradation of the electrolytic solution is suppressed due to the existence of the SEI coating, the discharge characteristics of the secondary battery after a charging and discharging cycle is considered to be improved. However, on the other hand, in a conventional secondary battery, the SEI coatings on the surfaces of the negative electrode and the positive electrode have not necessarily been considered to contribute to improvement in battery characteristics.

### CITATION LIST

### Patent Literature

Patent Literature 1: JP2013-149477 (A)

Patent Literature 2: JP2013-134922 (A)

Patent Literature 3: JP2013-145724 (A)

Patent Literature 4: JP2013-137873 (A)

Patent Literature 5: WO2015/045389

Patent Literature 6: JP2007-19027 (A)

### SUMMARY OF INVENTION

### Technical Problem

Lithium ion secondary batteries having long life have been required from the industry.

The present invention has been made in view of these circumstances, and an object of the present invention is to provide a lithium ion secondary battery having long life.

### Solution to Problem

The present inventors have conducted thorough investigation with many trials and errors. As a result, the present inventors have found that when a secondary battery including an electrolytic solution that contains a specific metal salt and a specific organic solvent is charged and discharged, specific materials appear on the surface of the negative electrode in some cases. Furthermore, the present inventors have found that: the materials influence battery characteristics; and in a lithium ion secondary battery having a small number of such materials, the capacity thereof is suitably maintained and the resistance thereof is reduced. On the basis of these findings, the present inventors have completed the present invention.

A lithium ion secondary battery of the present invention is a lithium ion secondary battery including: an electrolytic solution containing (FSO₂)₂NLi and a linear carbonate represented by general formula (A) below; and a negative electrode having a negative electrode active material, wherein

materials having a long diameter of 30 nm or greater exist on a surface of the negative electrode active material in a range of not less than 0 counts/μm² and less than 80 counts/μm².

R²⁰OCOOR²¹ general formula (A)

(R²⁰ and R²¹ are each independently selected from CₙHₐF_{b}Cl_{c}Br_{d}Iₑ that is a linear alkyl, or CₘH_{f}F_{g}ClₕBrᵢIⱼ that includes a cyclic alkyl in the chemical structure thereof. “n” is an integer not smaller than 1, “m” is an integer not smaller than 3, and “a”, “b”, “c”, “d”, “e”, “f”, “g”, “h”, “i”, and “j” are each independently an integer not smaller than 0, and satisfy 2n+1=a+b+c+d+e and 2m−1=f+g+h+i+j.)

### Advantageous Effects of Invention

The lithium ion secondary battery of the present invention has long life.

### BRIEF DESCRIPTION OF DRAWINGS

FIG. 1 is a schematic diagram of an SEM image of a coating of the present invention;

FIG. 2 is an X-ray photoelectron spectroscopy analysis chart regarding Li in lithium ion secondary batteries of Example VII, Example X, and Comparative Example IX;

FIG. 3 is an X-ray photoelectron spectroscopy analysis chart regarding C in the lithium ion secondary batteries of Example VII, Example X, and Comparative Example IX;

FIG. 4 is an X-ray photoelectron spectroscopy analysis chart regarding N in the lithium ion secondary batteries of Example VII, Example X, and Comparative Example IX;

FIG. 5 is an X-ray photoelectron spectroscopy analysis chart regarding O in the lithium ion secondary batteries of Example VII, Example X, and Comparative Example IX;

FIG. 6 is an X-ray photoelectron spectroscopy analysis chart regarding F in the lithium ion secondary batteries of Example VII, Example X, and Comparative Example IX;

FIG. 7 is an X-ray photoelectron spectroscopy analysis chart regarding S in the lithium ion secondary batteries of Example VII, Example X, and Comparative Example IX;

FIG. 8 is a graph of the relationship between ionic conductivity and mole ratio of a linear carbonate relative to a lithium salt obtained in Reference Evaluation Example 1;

FIG. 9 shows overlaid DSC curves obtained in Reference Evaluation Example 5; and

FIG. 10 shows overlaid DSC curves obtained in Reference Evaluation Example 6.

### DESCRIPTION OF EMBODIMENTS

The following describes embodiments of the present invention. Unless mentioned otherwise in particular, a numerical value range of “a to b (or, a-b)” described in the present specification includes, in the range thereof, a lower limit “a” and an upper limit “b”. A numerical value range is formed by arbitrarily combining such upper limit values, lower limit values, and numerical values described in Examples. In addition, numerical values arbitrarily selected within a numerical value range may be used as upper limit and lower limit numerical values.

The lithium ion secondary battery of the present invention is

a lithium ion secondary battery including: an electrolytic solution (hereinafter, sometimes referred to as electrolytic solution of the present invention) that contains (FSO₂)₂NLi and a linear carbonate represented by general formula (A) below; and a negative electrode having a negative electrode active material, wherein

materials having a long diameter of 30 nm or greater exist on a surface of the negative electrode active material in a range of not less than 0 counts/μm² and less than 80 counts/μm²,

R²⁰OCOOR²¹ general formula (A)

(R²⁰ and R²¹ are each independently selected from CₙHₐF_{b}Cl_{c}Br_{d}Iₑ that is a linear alkyl, or CₘH_{f}F_{g}ClₕBrᵢIⱼ that includes a cyclic alkyl in the chemical structure thereof. “n” is an integer not smaller than 1, “m” is an integer not smaller than 3, and “a”, “b”, “c”, “d”, “e”, “f”, “g”, “h”, “i”, and “j” are each independently an integer not smaller than 0, and satisfy 2n+1=a+b+c+d+e and 2m−1=f+g+h+i+j.).

The lithium ion secondary battery of the present invention is produced by adhering a degradation product obtained by degrading a component contained in the electrolytic solution of the present invention through charging and discharging of a lithium ion secondary battery including the electrolytic solution of the present invention under specific conditions, to the surface of the negative electrode active material. A coating (hereinafter, sometimes referred to as coating of the present invention) including the degradation product of the component contained in the electrolytic solution of the present invention is also considered to be formed on the surface of the negative electrode active material of the lithium ion secondary battery of the present invention.

When secondary electron image observation is performed using a scanning electron microscope, white materials having a long diameter of 30 nm or greater are confirmed on the surface of the negative electrode active material of the lithium ion secondary battery of the present invention in some cases. An example of one mode of the lithium ion secondary battery of the present invention is a lithium ion secondary battery in which the number of materials having a long diameter of 30 nm or greater on the surface of the negative electrode active material is greater than 0 counts/μm² and less than 80 counts/μm², 0.1 to 30 counts/μm², or 0.5 to 20 counts/μm². The smaller the number of materials is, the more suitable the capacity retention rate of the lithium ion secondary battery is.

The long diameter means the length at the longest portion in a white material in an observed scanning electron microscopic image. The upper limit of the long diameter of white materials is not particularly limited, but an example of a practical upper limit is 500 nm.

The lithium ion secondary battery of the present invention is also represented as a lithium ion secondary battery including the electrolytic solution of the present invention and a negative electrode having a negative electrode active material, the lithium ion secondary battery including a coating in which materials having a long diameter of 30 nm or greater exist on the surface of the negative electrode active material in a range of not less than 0 counts/μm² and less than 80 counts/μm².

As a result of investigation, the present inventors have found that the white materials have a higher F content than a portion of the coating of the present invention other than the materials. The materials are considered to be derived mainly from (FSO₂)₂NLi. As one mode of the coating of the present invention, a coating that includes materials having a long diameter of 30 nm or greater and in which a value of (concentration of F in the material)/(concentration of F in the coating of the present invention other than the material) exceeds 1 is understood. In addition, as one mode of the lithium ion secondary battery, a lithium ion secondary battery in which (concentration of F in the material)/(concentration of F in the surface of the negative electrode active material other than the material) exceeds 1 is understood. Hereinafter, the “coating of the present invention” may be replaced with “surface of the negative electrode active material” without departing from the gist of each sentence.

The concentration of (FSO₂)₂NLi in the electrolytic solution of the present invention is not particularly limited, but is preferably in a range of 1.1 to 3.8 mol/L, more preferably in a range of 1.5 to 3.5 mol/L, and further preferably in a range of 2.0 to 3.0 mol/L. When the concentration of (FSO₂)₂NLi is excessively low or excessively high, the capacity retention rate of the lithium ion secondary battery decreases in some cases. In addition, from the viewpoint of satisfying both ionic conductivity and low-temperature stability of the electrolytic solution in good balance, the above range for the concentration of (FSO₂)₂NLi in the electrolytic solution of the present invention is appropriate.

The electrolytic solution of the present invention may contain another electrolyte usable in an electrolytic solution for power storage devices, in addition to (FSO₂)₂NLi. In the electrolytic solution of the present invention, (FSO₂)₂NLi is contained by preferably not less than 50 mass %, more preferably not less than 70 mass %, and further preferably not less than 90 mass %, relative to the entire electrolyte contained in the electrolytic solution of the present invention. The entire electrolyte contained in the electrolytic solution of the present invention may be (FSO₂)₂NLi.

Examples of the other electrolyte include LiPF₆, LiBF₄, LiAsF₆, Li₂SiF₆, (CF₃SO₂)₂NLi, (C₂F₅SO₂)₂NLi, FSO₂(CF₃SO₂)NLi, (SO₂CF₂CF₂SO₂)NLi, (SO₂CF₂CF₂CF₂SO₂)NLi, FSO₂(CH₃SO₂)NLi, FSO₂(C₂F₅SO₂)NLi, FSO₂(C₂H₅SO₂)NLi, (OCOCO₂)₂BLi, or (OCOCO₂)BF₂Li.

The electrolytic solution of the present invention contains a linear carbonate represented by general formula (A) (hereinafter, sometimes referred to merely as “linear carbonate”) as an organic solvent. In the electrolytic solution of the present invention, the linear carbonate is contained at a mole ratio of preferably 3 to 6 and more preferably 3 to 5 relative to (FSO₂)₂NLi.

As the linear carbonate, one type may be used in the electrolytic solution, or a plurality of types may be used in combination in the electrolytic solution. When a plurality of linear carbonates are used in combination, low-temperature fluidity, lithium ion transport at a low temperature, and the like of the electrolytic solution are suitably ensured.

In the linear carbonates, “n” is preferably an integer from 1 to 6, more preferably an integer from 1 to 4, and particularly preferably an integer from 1 to 2. “m” is preferably an integer from 3 to 8, more preferably an integer from 4 to 7, and particularly preferably an integer from 5 to 6.

Among the linear carbonates, those represented by general formula (A-1) below are particularly preferable.

R²²OCOOR²³ general formula (A-1)

(R²² and R²³ are each independently selected from CₙHₐF_{b} that is a linear alkyl, or CₘH_{f}F_{g} that includes a cyclic alkyl in the chemical structure thereof. “n” is an integer not smaller than 1, “m” is an integer not smaller than 3, and “a”, “b”, “f”, and “g” are each independently an integer not smaller than 0, and satisfy 2n+1=a+b and 2m−1=f+g.)

In the linear carbonates represented by general formula (A-1), “n” is preferably an integer from 1 to 6, more preferably an integer from 1 to 4, and particularly preferably an integer from 1 to 2. “m” is preferably an integer from 3 to 8, more preferably an integer from 4 to 7, and particularly preferably an integer from 5 to 6.

Among the linear carbonates, dimethyl carbonate (hereinafter, sometimes referred to as “DMC”), diethyl carbonate (hereinafter, sometimes referred to as “DEC”), ethyl methyl carbonate (hereinafter, sometimes referred to as “EMC”), fluoromethyl methyl carbonate, difluoromethyl methyl carbonate, trifluoromethyl methyl carbonate, bis(fluoromethyl)carbonate, bis(difluoromethyl)carbonate, bis(trifluoromethyl)carbonate, fluoromethyl difluoromethyl carbonate, 2,2,2-trifluoroethyl methyl carbonate, pentafluoroethyl methyl carbonate, ethyl trifluoromethyl carbonate, and bis(2,2,2-trifluoroethyl)carbonate are particularly preferable.

The electrolytic solution of the present invention may contain another organic solvent usable in electrolytic solutions for lithium ion secondary batteries and the like (hereinafter, sometimes referred to merely as “another organic solvent”), in addition to the linear carbonate.

In the electrolytic solution of the present invention, the linear carbonate is contained, relative to the entire organic solvent contained in the electrolytic solution of the present invention, by preferably not less than 70 mass % or 70 mole %, more preferably not less than 80 mass % or 80 mole %, further preferably not less than 90 mass % or 90 mole %, and particularly preferably not less than 95 mass % or 95 mole %. The entire organic solvent contained in the electrolytic solution of the present invention may be the linear carbonate.

In some cases, the electrolytic solution of the present invention containing another organic solvent in addition to the linear carbonate has an increased viscosity or a reduced ionic conductivity compared to the electrolytic solution of the present invention not containing another organic solvent. Furthermore, in some cases, a secondary battery using the electrolytic solution of the present invention containing another organic solvent in addition to the linear carbonate has an increased reaction resistance.

Specific examples of the other organic solvent include nitriles such as acetonitrile, propionitrile, acrylonitrile, and malononitrile, ethers such as 1,2-dimethoxyethane, 1,2-diethoxyethane, tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, and crown ethers, cyclic carbonates such as ethylene carbonate and propylene carbonate, amides such as formamide, N,N-dimethylformamide, N,N-dimethylacetamide, and N-methylpyrrolidone, isocyanates such as isopropyl isocyanate, n-propylisocyanate, and chloromethyl isocyanate, esters such as methyl acetate, ethyl acetate, butyl acetate, propyl acetate, methyl propionate, methyl formate, ethyl formate, vinyl acetate, methyl acrylate, and methyl methacrylate, epoxies such as glycidyl methyl ether, epoxy butane, and 2-ethyloxirane, oxazoles such as oxazole, 2-ethyloxazole, oxazoline, and 2-methyl-2-oxazoline, ketones such as acetone, methyl ethyl ketone, and methyl isobutyl ketone, acid anhydrides such as acetic anhydride and propionic anhydride, sulfones such as dimethyl sulfone and sulfolane, sulfoxides such as dimethyl sulfoxide, nitros such as 1-nitropropane and 2-nitropropane, furans such as furan and furfural, cyclic esters such as γ-butyrolactone, γ-valerolactone, and δ-valerolactone, aromatic heterocycles such as thiophene and pyridine, heterocycles such as tetrahydro-4-pyrone, 1-methylpyrrolidine, and N-methylmorpholine, and phosphoric acid esters such as trimethyl phosphate and triethyl phosphate.

Compared to a cyclic carbonate such as ethylene carbonate which has been used in a conventional electrolytic solution, the linear carbonate represented by general formula (A) has a low polarity. Therefore, the affinity between the linear carbonate and metal ions is considered to be inferior compared to the affinity between the cyclic carbonate and metal ions. Then, when the electrolytic solution of the present invention is used as the electrolytic solution for a secondary battery, aluminum or a transition metal forming an electrode of the secondary battery is considered less likely to be dissolved as ions into the electrolytic solution of the present invention.

Here, regarding a secondary battery using a conventional general electrolytic solution, a possible case is known in which: aluminum or a transition metal forming the positive electrode enters a high oxidation state particularly in a high-voltage charging environment, and dissolves (anode elution) in the form of metal ions, which are positive ions, into the electrolytic solution; and then, the metal ions eluted in the electrolytic solution are attracted to the electron-rich negative electrode by electrostatic attraction, to bind with electrons on the negative electrode, thereby to be reduced and deposited in the form of metal. If such a reaction occurs, the performance of the battery is known to be reduced due to possible occurrence of decrease in the capacity of the positive electrode, degradation of the electrolytic solution on the negative electrode, and the like. However, the electrolytic solution of the present invention has the features described in the former paragraphs, and thus, in a secondary battery using the electrolytic solution of the present invention, metal ion elution from the positive electrode and metal deposition on the negative electrode are suppressed.

In the suitable electrolytic solution of the present invention, the concentration of the metal salt indicating a suitable ionic conductivity is relatively high. In addition, the linear carbonate represented by the above general formula (A) is excellent in stability against oxidation and reduction. Furthermore, the linear carbonate represented by the above general formula (A) has a flexible chemical structure in which many bindings capable of free rotation exist. Thus, even when the electrolytic solution of the present invention using the linear carbonate contains a high concentration of a metal salt, significant increase in the viscosity thereof is suppressed, and high ionic conductivity is obtained.

In the suitable electrolytic solution of the present invention, the existence proportion of the metal salt is considered to be high compared to that in conventional electrolytic solutions. Then, in the suitable electrolytic solution of the present invention, the environment in which the metal salt and the organic solvent exist is considered to be different from that in conventional electrolytic solutions. Therefore, in a power storage device such as a secondary battery using the suitable electrolytic solution of the present invention, improvement in metal ion transportation rate in the electrolytic solution, improvement in reaction rate at the interface between an electrode and the electrolytic solution, mitigation of uneven distribution of metal salt concentration of the electrolytic solution caused when the secondary battery undergoes high-rate charging and discharging, improvement in liquid retaining property of the electrolytic solution at an electrode interface, suppression of a so-called liquid run-out state of lacking the electrolytic solution at an electrode interface, increase in the capacity of an electrical double layer, and the like are expected. Furthermore, in the suitable electrolytic solution of the present invention, the vapor pressure of the organic solvent contained in the electrolytic solution becomes low. As a result, volatilization of the organic solvent from the suitable electrolytic solution of the present invention is reduced.

The suitable electrolytic solution of the present invention contains a cation of the metal salt at a relatively high concentration. Thus, the distance between adjacent cations is extremely small within the suitable electrolytic solution of the present invention. When a cation such as a lithium ion moves between the positive electrode and the negative electrode during charging and discharging of the secondary battery, a cation located closest to an electrode that is a movement destination is firstly supplied to the electrode. Then, another cation adjacent to the cation moves to the place where the supplied cation had been located. Thus, in the suitable electrolytic solution of the present invention, a domino toppling-like phenomenon is predicted to be occurring in which adjacent cations sequentially change their positions one by one toward an electrode that is a supply target. Because of that, the distance for which a cation moves during charging and discharging is considered to be short, so that the movement speed of the cation is considered to be high. For this reason, the secondary battery having the suitable electrolytic solution of the present invention is considered to have a high reaction rate.

The electrolytic solution of the present invention may contain an unsaturated cyclic carbonate. The lithium ion secondary battery of the present invention is produced by charging and discharging, under specific conditions, a lithium ion secondary battery including an electrolytic solution that does not contain an unsaturated cyclic carbonate, but is produced under milder charging and discharging conditions from a lithium ion secondary battery including an electrolytic solution that contains an unsaturated cyclic carbonate.

The unsaturated cyclic carbonate refers to a cyclic carbonate having a carbon-carbon double bond in the molecule thereof. Because of the existence of the unsaturated cyclic carbonate, the capacity retention rate of the lithium ion secondary battery improves. The unsaturated cyclic carbonate is preferably contained by greater than 0 mass % and not greater than 6.5 mass % relative to the entire electrolytic solution.

From the technical viewpoint of reducing the resistance of the lithium ion secondary battery, the unsaturated cyclic carbonate is preferably contained by 0.1 to 1.5 mass % relative to the entire electrolytic solution.

Specific examples of the unsaturated cyclic carbonate include compounds represented by general formula (1) below.

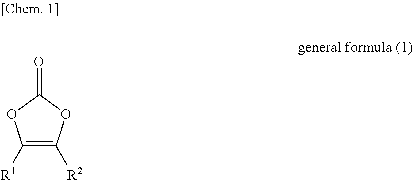

(R¹ and R² are each independently hydrogen, an alkyl group, a halogen-substituted alkyl group, or a halogen)

Examples of specific compound names of the unsaturated cyclic carbonates represented by general formula (1) include vinylene carbonate, fluorovinylene carbonate, methylvinylene carbonate, fluoromethylvinylene carbonate, ethylvinylene carbonate, propylvinylene carbonate, butylvinylene carbonate, dimethylvinylene carbonate, diethylvinylene carbonate, dipropylvinylene carbonate, and trifluoromethylvinylene carbonate. Among them, vinylene carbonate is preferable.

Another specific example of the unsaturated cyclic carbonate is a compound in which the carbon-carbon double bond in general formula (1) is outside the ring, and an example of a specific compound name thereof is vinyl ethylene carbonate.

The unsaturated cyclic carbonate is speculated to be degraded during charging and/or discharging of the lithium ion secondary battery, thereby forming a carbon-containing coating on the negative electrode active material and/or the positive electrode active material. Because of the existence of the carbon-containing coating, excessive degradation of the electrolytic solution is considered to be suppressed, resulting in extension of the life of the lithium ion secondary battery.

One mode of the electrolytic solution of the present invention not containing the unsaturated cyclic carbonate is mainly degraded at a potential of approximately 0.6 V based on metal lithium in the existence of a graphite. On the other hand, one mode of the electrolytic solution of the present invention containing the unsaturated cyclic carbonate is mainly degraded, for example, at a potential of approximately 0.8±0.1 V based on metal lithium in the existence of a graphite. That is, the one mode of the electrolytic solution of the present invention containing the unsaturated cyclic carbonate is considered to be more easily degraded under lithium ion secondary battery charging conditions, than the one mode of the electrolytic solution of the present invention not containing the unsaturated cyclic carbonate.

The ease of degradation of the electrolytic solution of the present invention is confirmed by subjecting the electrolytic solution of the present invention to analysis such as cyclic voltammetry. For example, as for cyclic voltammetry, the degradation potential of the electrolytic solution of the present invention is confirmed by applying the electrolytic solution of the present invention to a device having a graphite-containing electrode as a working electrode, linearly sweeping the electrode potential, and measuring a value of response current with respect to each potential, or calculating an amount of change in response current with respect to an amount of change in potential.

The electrolytic solution of the present invention may contain an organic solvent formed from a hydrocarbon. The electrolytic solution of the present invention containing the organic solvent formed from the hydrocarbon is expected to have an effect that the viscosity thereof is reduced.

Specific examples of the organic solvent formed from the above hydrocarbon include benzene, toluene, ethyl benzene, o-xylene, m-xylene, p-xylene, 1-methylnaphthalene, hexane, heptane, and cyclohexane.

In addition, a fire-resistant solvent may be added to the electrolytic solution of the present invention. By adding the fire-resistant solvent to the electrolytic solution of the present invention, safety of the electrolytic solution of the present invention is further enhanced. Examples of the fire-resistant solvent include halogen based solvents such as carbon tetrachloride, tetrachloroethane, and hydrofluoroether, and phosphoric acid derivatives such as trimethyl phosphate and triethyl phosphate.

When the electrolytic solution of the present invention is mixed with a polymer or an inorganic filler to form a mixture, the mixture enables containment of the electrolytic solution to provide a pseudo solid electrolyte. By using the pseudo solid electrolyte as an electrolytic solution of a battery, leakage of the electrolytic solution in the battery is suppressed.

As the polymer, a polymer used in batteries such as lithium ion secondary batteries and a general chemically cross-linked polymer are used. In particular, a polymer capable of turning into a gel by absorbing an electrolytic solution, such as polyvinylidene fluoride and polyhexafluoropropylene, and one obtained by introducing an ion conductive group to a polymer such as polyethylene oxide are suitable.

Specific examples of the polymer include polymethylacrylate, polymethyl methacrylate, polyethylene oxide, polypropylene oxide, polyacrylonitrile, polyvinylidene fluoride, polyethylene glycol dimethacrylate, polyethylene glycol acrylate, polyglycidol, polytetrafluoroethylene, polyhexafluoropropylene, polysiloxane, polyvinyl acetate, polyvinyl alcohol, polyacrylic acid, polymethacrylic acid, polyitaconic acid, polyfumaric acid, polycrotonic acid, polyangelic acid, polycarboxylic acid such as carboxymethyl cellulose, styrene-butadiene rubbers, nitrile-butadiene rubbers, polystyrene, polycarbonate, unsaturated polyester obtained through copolymerization of maleic anhydride and glycols, polyethylene oxide derivatives having a substituent group, and a copolymer of vinylidene fluoride and hexafluoropropylene. In addition, as the polymer, a copolymer obtained through copolymerization of two or more types of monomers forming the above described specific polymers may be selected.

Polysaccharides are also suitable as the polymer. Specific examples of the polysaccharides include glycogen, cellulose, chitin, agarose, carrageenan, heparin, hyaluronic acid, pectin, amylopectin, xyloglucan, and amylose. In addition, materials containing these polysaccharides may be used as the polymer, and examples of the materials include agar containing polysaccharides such as agarose.

As the inorganic filler, inorganic ceramics such as oxides and nitrides are preferable.

Inorganic ceramics have hydrophilic and hydrophobic functional groups on their surfaces. Thus, a conductive passage may form within the inorganic ceramics when the functional groups attract the electrolytic solution. Furthermore, the inorganic ceramics dispersed in the electrolytic solution form a network among the inorganic ceramics themselves due to the functional groups, and may serve as containment of the electrolytic solution. With such a function by the inorganic ceramics, leakage of the electrolytic solution in the battery is further suitably suppressed. In order to have the inorganic ceramics suitably exert the function described above, the inorganic ceramics having a particle shape are preferable, and those whose particle sizes are nm order are particularly preferable.

Examples of the types of the inorganic ceramics include common alumina, silica, titania, zirconia, and lithium phosphate. In addition, inorganic ceramics that have lithium conductivity themselves are preferable, and specific examples thereof include Li₃N, LiI, LiI—Li₃N—LiOH, LiI—Li₂S—P₂O₅, LiI—Li₂S—P₂S₅, LiI—Li₂S—B₂S₃, Li₂O—B₂S₃, Li₂O—V₂O₃—SiO₂, Li₂O—B₂O₃—P₂O₅, Li₂O—B₂O₃—ZnO, Li₂O—Al₂O₃—TiO₂—SiO₂—P₂O₅, LiTi₂(PO₄)₃, Li-βAl₂O₃, and LiTaO₃.

Glass ceramics may be used as the inorganic filler. Since glass ceramics enables containment of ionic liquids, the same effect is expected for the electrolytic solution of the present invention. Examples of the glass ceramics include compounds represented by xLi₂S-(1-x)P₂S₅ (0<x<1), and those in which one portion of S in the compound is substituted with another element and those in which one portion of P in the compound is substituted with germanium.

In addition, without departing from the gist of the present invention, a known additive may be added to the electrolytic solution of the present invention. Examples of such a known additive include: carbonate compounds represented by fluoro ethylene carbonate, trifluoro propylene carbonate, phenylethylene carbonate, and erythritane carbonate; carboxylic anhydrides represented by succinic anhydride, glutaric anhydride, maleic anhydride, citraconic anhydride, glutaconic anhydride, itaconic anhydride, diglycolic anhydride, cyclohexanedicarboxylic anhydride, cyclopentanetetracarboxylic dianhydride, and phenyl succinic anhydride; lactones represented by γ-butyrolactone, γ-valerolactone, γ-caprolactone, δ-valerolactone, δ-caprolactone, and ε-caprolactone; cyclic ethers represented by 1,4-dioxane; sulfur-containing compounds represented by ethylene sulfite, 1,3-propanesultone, 1,4-butanesultone, methyl methanesulfonate, busulfan, sulfolane, sulfolene, dimethyl sulfone, and tetramethylthiuram monosulfide; nitrogen-containing compounds represented by 1-methyl-2-pyrrolidinone, 1-methyl-2-piperidone, 3-methyl-2-oxazolidinone, 1,3-dimethyl-2-imidazolidinone, and N-methylsuccinimide; phosphates represented by monofluorophosphate and difluorophosphate; saturated hydrocarbon compounds represented by heptane, octane, and cycloheptane; and unsaturated hydrocarbon compounds represented by biphenyl, alkyl biphenyl, terphenyl, partially hydrogenated terphenyl, cyclohexylbenzene, t-butylbenzene, t-amyl benzene, diphenyl ether, and dibenzofuran.

In the electrolytic solution of the present invention, the chemical structure of (FSO₂)₂NLi includes SO₂. In the lithium ion secondary battery of the present invention, (FSO₂)₂NLi is inferred to be degraded through charging and discharging of the lithium ion secondary battery, thereby forming an S- and O-containing coating on the surface of the positive electrode and/or the negative electrode. The S- and O-containing coating is inferred to have an S═O structure. Since deterioration of the electrodes and the electrolytic solution is suppressed by the electrodes being coated with the coating, the durability of the secondary battery is considered to be improved.

In the suitable electrolytic solution of the present invention, a cation and an anion are considered to exist closer to each other when compared to a conventional electrolytic solution, and thus the anion is considered to be more likely to be reduced and degraded by being under strong electrostatic influence from the cation when compared to a conventional electrolytic solution. In a conventional secondary battery using a conventional electrolytic solution, an SEI coating is formed from a degradation product generated by reductive degradation of a cyclic carbonate such as ethylene carbonate contained in the electrolytic solution. However, as described above, in the suitable electrolytic solution of the present invention contained in the lithium ion secondary battery of the present invention, the anion is easily reduced and degraded, and in addition, the metal salt is contained at a relatively higher concentration than in a conventional electrolytic solution, and thus, the anion concentration in the electrolytic solution is high. Thus, the SEI coating, i.e., the S- and O-containing coating, in the lithium ion secondary battery of the present invention is considered to contain much degradation product derived from the anion. In addition, in the lithium ion secondary battery of the present invention, the SEI coating is formed without using a cyclic carbonate such as ethylene carbonate.

In addition, the linear carbonate contained in the electrolytic solution of the present invention and the unsaturated cyclic carbonate that may be contained in the electrolytic solution of the present invention are also speculated to be degraded during charging and discharging of the lithium ion secondary battery, thereby forming a carbon-containing coating on the negative electrode active material and/or on the positive electrode active material. Thus, in the lithium ion secondary battery of the present invention, a coating containing S, O, and C is considered to be formed on the surface of the negative electrode active material and/or the positive electrode active material. The coating is inferred to also contain Li, N, and F. That is, the coating of the present invention is considered to contain Li, S, F, O, N, and C.

Among the lithium ion secondary batteries of the present invention, a lithium ion secondary battery including the coating of the present invention on the surface of the negative electrode is particularly important. The reason is that, because of the existence of the coating of the present invention on the surface of the negative electrode, excessive reductive degradation of the electrolytic solution during charging is suppressed.

From the viewpoint of the previous paragraph, a suitable existence amount of the unsaturated cyclic carbonate in the lithium ion secondary battery of the present invention before charging and discharging is calculated also on the basis of a relationship with the surface area of the negative electrode. In the lithium ion secondary battery of the present invention, the value of (mass (mg) of unsaturated cyclic carbonate/surface area (m²) of negative electrode) is preferably in a range of 2.5 to 300, more preferably in a range of 2.6 to 60, and further preferably in a range of 2.6 to 30. The “surface area of the negative electrode” refers to a value obtained by multiplying a specific surface area (m²/g) of a negative electrode active material layer excluding a negative electrode current collector by the total mass (g) of the negative electrode active material in the lithium ion secondary battery, the specific surface area (m²/g) being measured by the BET method.

In some cases, the state of the coating of the present invention in the lithium ion secondary battery of the present invention changes associated with charging and discharging. For example, in some cases, the thickness of the coating of the present invention and the proportion of elements in the coating reversibly change depending on the state of charging and discharging. Thus, a portion that is derived from the degradation product of the anion as described above and is fixed in the coating, and a portion that reversibly increases and decreases associated with charging and discharging, are considered to exist in the coating of the present invention in the lithium ion secondary battery of the present invention.

Since the coating of the present invention is considered to be derived from the degradation product of the electrolytic solution, a large portion or the entirety of the coating of the present invention is considered to be produced during and after the first charging and discharging of the secondary battery. Components of the coating of the present invention are considered to be different in some cases, depending on the composition of the electrode, the components contained in the electrolytic solution, or the like.

The lithium ion secondary battery of the present invention includes the coating of the present invention on the negative electrode, and the coating of the present invention is considered to have an S═O structure and contain a large amount of Li. In addition, Li contained in the coating of the present invention is considered to be preferentially supplied to the electrode. Thus, since the lithium ion secondary battery of the present invention has an abundant Li source near the electrode, a transportation rate of Li is considered to be also improved. Accordingly, the lithium ion secondary battery of the present invention is considered to exhibit excellent battery characteristics because of cooperation between the electrolytic solution of the present invention and the coating of the present invention on the electrode.

The coating of the present invention is preferably observed to have at least one of the following peaks when the binding energy of elements contained in the coating is measured by using X-ray photoelectron spectroscopy.

S: Peak having the peak top at 169±2 eV (hereafter, sometimes abbreviated as “169 eV peak”)

O: Peak having the peak top at 532±2 eV (hereinafter, sometimes abbreviated as “532 eV peak”)

C: Peak having the peak top at 290±2 eV (hereinafter, sometimes abbreviated as “290 eV peak”)

C: Peak having the peak top at 285±1 eV (hereinafter, sometimes abbreviated as “285 eV peak”)

The peak regarding the binding energy described above is inferred to be attributed to at least one of the following bonds.

S: 169 eV peak->S-Ox bond (x is an integer from 1 to 4), S═O bond

C: 290 eV peak->CO₃ bond

C: 285 eV peak->C—H bond, C—C bond, C═C bond

Attributions of the above peaks are also supported through quantum chemistry calculation. Actually, with respect to the attribution of carbon, when the molecular structure was optimized by using density functional theory and the level of is orbital of carbon was calculated, validity of attributions of the peaks described above was supported. As the quantum chemistry calculation program, Gaussian09 (registered trademark, Gaussian, Inc.) was used, the density functional was B3LYP, and the basis function was 6-311++G (d, p) in which a polarization function and a dispersion function were added.

From the above attributions, one mode of the coating of the present invention is considered to have S-Ox bond, S═O bond, CO₃ bond, C—H bond, C—C bond, and/or C═C bond.

From the above attribution, the 290 eV peak is considered to be derived from the linear carbonate or the unsaturated cyclic carbonate. In addition, from Evaluation Example III described later, a peak derived from carbon was found to be observed at a location of an eV value obtained by subtracting 2.3 eV from the eV value of the peak top in the 290 eV peak, from an electrolytic solution containing a large amount of the unsaturated cyclic carbonate. The peak derived from carbon (hereinafter, referred to as “−2.3 eV peak”) is considered to be derived from the unsaturated cyclic carbonate.

From the results of Evaluation Example II described later, a lithium ion secondary battery including an electrolytic solution containing a large amount of the unsaturated cyclic carbonate was found to have an increased resistance. From the results of Evaluation Example II and Evaluation Example III described later, a lower signal value of the “−2.3 eV peak” is considered to be preferable for the coating of the present invention. Regarding the relationship between the −2.3 eV peak and the 290 eV peak, the value of ((signal value of 290 eV peak)/(signal value of −2.3 eV peak)) is considered to be preferably not less than 0.7, more preferably not less than 0.8 and not greater than 2.0, and further preferably not less than 1.3 and not greater than 1.8.

Examples of the ranges of the percentages of elements such as Li, C, N, O, F, and S in the surface of the negative electrode of the lithium ion secondary battery of the present invention are shown below. The percentages of the elements are values calculated from analysis results obtained through X-ray photoelectron spectroscopy.

Li: 10 to 30 atm %, C: 20 to 60 atm %, N: 0.5 to 5 atm %, O:20 to 50 atm %, F: 0.5 to 5 atm %, S: 0.5 to 5 atm %

Examples of suitable ranges of the percentages of the elements in the surface of the negative electrode of the lithium ion secondary battery of the present invention are shown below.

Li: 15 to 20 atm %, C: 35 to 50 atm %, N: 1 to 3 atm %, O: 29 to 33 atm %, F: 1 to 4.5 atm %, S: 1 to 3.5 atm %

An example of a more suitable range of the percentage of carbon in the surface of the negative electrode of the lithium ion secondary battery of the present invention is 40.2 to 49.1 atm %.

The sum of the percentages of N, F, and S, derived from the anion of (FSO₂)₂NLi, in the surface of the negative electrode of the lithium ion secondary battery of the present invention is preferably 5.1 to 10.4 atm % and more preferably 6 to 8 atm %.

As a result of thorough investigation by the present inventors, the present inventors have found a plurality of methods for the lithium ion secondary battery of the present invention. These methods are understandable as an adjustment method or an activation method for the lithium ion secondary battery of the present invention. In addition, these methods are considered as methods for producing the coating of the present invention.

One mode of the method for producing the lithium ion secondary battery of the present invention is characterized by performing, on a lithium ion secondary battery including the electrolytic solution of the present invention, a negative electrode, and a positive electrode, an activation process including step (a), step (b), and step (c) described below, or step (a) and step (d) described below. Without departing from the gist of the present invention, a current pause time or a voltage keeping time may be provided in each step or between steps.

(a) Step of performing charging to a second voltage V₂ in step (a-1) or step (a-2) described below.

(a-1) Step of performing charging at a first rate C₁ to a first voltage V₁ and then performing charging at a second rate C₂ to the second voltage V₂ (V₁<V₂, C₁<C₂, C₂ is not less than 1C).

(a-2) Step of performing charging at a constant charging rate Cₐ₋₂ of 1C or higher to the second voltage V₂.

(b) Step of discharging the lithium ion secondary battery having been subjected to step (a), at a third rate C₃ to a third voltage V₃ or lower.

(c) Step of performing charging and discharging at a fourth rate C₄ between the third voltage V₃ and the second voltage V₂.

(d) Step of keeping the temperature of the lithium ion secondary battery in a range of 40 to 120° C.

In step (a), either step (a-1) or step (a-2) is selected to charge the lithium ion secondary battery to the second voltage V₂. Step (a) may be performed at an ordinary temperature (25° C.), or under a cooling condition or a heating condition. Step (a) is preferably performed under a constant temperature condition. The range of the second voltage V₂ is 3.5 to 6 V, preferably 3.6 to 5.5 V, more preferably 3.7 to 5 V, and further preferably 3.8 to 4.5 V, for example.

Step (a-1) is a step of performing charging at the first rate C₁ to the first voltage V₁, and then performing charging at the second rate C₂ to the second voltage V₂ (V₁<V₂, C₁<C₂, C₂ is not less than 1C). As the first voltage V₁, a voltage satisfying 0.5×V₂<V₁<V₂ is preferable, a voltage satisfying 0.6×V₂<V₁<0.95×V₂ is more preferable, and a voltage satisfying 0.7×V₂<V₁<0.9×V₂ is further preferable.

The relationship between the first rate C₁ and the second rate C₂ is C₁<C₂, and is preferably C₁<0.7×C₂, more preferably C₁<0.5×C₂, and further preferably C₁<0.3×C₂. Specific examples of the first rate C₁ include 0.05 C, 0.1 C, and 0.2 C. Specific examples of the second rate C₂ include 1 C, 3 C, and 5 C. 1 C means a current value required for fully charging or discharging the secondary battery in 1 hour with a constant current. 2C means a current value required for fully charging or discharging the secondary battery in 0.5 hours with a constant current.

Step (a-2) is a step of performing charging at a constant charging rate Cₐ₋₂ of 1 C or greater to a second voltage V₂. The charging rate Cₐ₋₂ is preferably 2 C or greater and more preferably 3 C or greater. Examples of the range of the charging rate Cₐ₋₂ include 1 C≤Cₐ₋₂≤15 C, 2 C≤Cₐ₋₂≤13 C, and 3 C≤Cₐ₋₂≤11 C.

In each of step (a-1) and step (a-2), after charging to the second voltage V₂ has been performed, charging for keeping the voltage is preferably performed. Examples of the second voltage V₂ keeping period include 0.5 to 5 hours and 1 to 3 hours.

In one mode of the method for producing the lithium ion secondary battery of the present invention, a charging and discharging step including step (b) and step (c) described below, or a process including step (d) described below is performed on the lithium ion secondary battery having been subjected to step (a) described above.

(b) a step of performing discharging the lithium ion secondary battery having been subjected to step (a), at the third rate C₃ to the third voltage V₃ or lower.

(c) a step of performing charging and discharging at the fourth rate C₄ between the third voltage V₃ and the second voltage V₂.

(d) a step of keeping the temperature of the lithium ion secondary battery in a range of 40 to 120° C.

First, the charging and discharging step including step (b) and step (c) is described.

The discharge voltage in step (b) may be any voltage not greater than the third voltage V₃ in step (c), and examples of the range thereof include 0.8×V₃ to V₃.

Examples of the range of the third rate C₃ include 0.5 C≤C₃≤10 C, 0.5 C≤C₃≤6 C, 1 C≤C₃≤6 C, 0.5 C≤C₃≤3 C, and 1 C≤C₃≤3 C.

Step (b) may be performed at an ordinary temperature (25° C.) , or under a cooling condition or a heating condition. Step (b) is preferably performed under a constant temperature condition. After discharging in step (b) has been ended, charging for keeping the voltage is preferably performed. Examples of the keeping period include 0.5 to 5 hours and 1 to 3 hours.

As the third voltage V₃ in step (c), a voltage satisfying 0.5×V₂<V₃<V₂ is preferable, a voltage satisfying 0.6×V₂<V₃<0.9×V₂ is more preferable, and a voltage satisfying 0.7×V₂<V₃<0.90×V₂ is further preferable.

Examples of the range of the fourth rate C₄ in step (c) include 0.5 C≤C₄≤10 C, 1 C≤C₄≤6C, and 1 C≤C₄≤3 C. C₃<C₄ is preferable. When step (a) is step (a-1), the relationship among the first rate C₁, the second rate C₂, the third rate C₃, and the fourth rate C₄ preferably satisfies C₁<C₂<C₃<C₄.

The temperature in step (c) is preferably in a range of 40 to 120° C., and more preferably in a range of 50 to 100° C. Step (c) is preferably performed under a constant temperature condition. In addition, step (c) is preferably repeated. Examples of the number of times of the repetition include 5 to 50 times, and 20 to 40 times. After each charging and discharging in step (c), charging for keeping the voltage may be performed. Examples of the keeping period include 0.1 to 2 hours, and 0.2 to 1 hours.

Next, step (d) is described. In step (d), the temperature of the lithium ion secondary battery may be kept in a range of 40 to 120° C. while keeping constant the voltage of the charged lithium ion secondary battery having been subjected to step (a). Alternatively, the temperature of the lithium ion secondary battery maybe kept in a range of 40 to 120 ° C. without keeping constant (naturally occurring voltage) the voltage of the charged lithium ion secondary battery having been subjected to step (a). Further, in step (d), after the voltage of the lithium ion secondary battery is once adjusted to a specific value, the temperature of the lithium ion secondary battery may be kept in a range of 40 to 120° C. An example of a more preferable temperature range for step (d) is 50 to 120° C., and an example of a further preferable temperature range for step (d) is 50 to 100° C.

Examples of the temperature keepingperiod in step (d) include 0.5 to 48 hours, 12 to 36 hours, and 18 to 30 hours. Step (d) may be performed on the secondary battery having been subjected to step (c).

In the case where the electrolytic solution of the present invention contains an unsaturated cyclic carbonate, the lithium ion secondary battery of the present invention is also produced by a method in which step (a) described above is replaced by step (a) described below. Step (a-3) or step (a-4) described below is a mild charging step compared to step (a-1) or step (a-2) described above. In the case where the electrolytic solution of the present invention contains an unsaturated cyclic carbonate, the coating of the present invention is formed on the surface of the negative electrode active material even through a mild charging step. Steps subsequent to step (a) are the same as those in the above-described activation process.

(a) Step of performing charging to a second voltage V₂ in step (a-3) or step (a-4) described below.

(a-3) Step of performing charging at a first rate C₁ to a first voltage V₁ and then performing charging at a second rate C₂ to the second voltage V₂ (V₁<V₂, C₁<C₂).

(a-4)) Step of performing charging at a constant charging rate Cₐ₋₂ of 0.05 C or higher to the second voltage V₂.

In step (a), either step (a-3) or step (a-4) is selected to charge the lithium ion secondary battery to the second voltage V₂. Step (a) may be performed at an ordinary temperature (25° C.), or under a cooling condition or a heating condition. Step (a) is preferably performed under a constant temperature condition. The range of the second voltage V₂ is 3.5 to 6 V, preferably 3.6 to 5.5 V, more preferably 3.7 to 5 V, and further preferably 3.8 to 4.5 V, for example.

Step (a-3) is a step of performing charging at the first rate C₁ to the first voltage V₁, and then performing charging at the second rate C₂ to the second voltage V₂ (V₁<V₂, C₁<C₂). As the first voltage V₁, a voltage satisfying 0.5×V₂<V₁<V₂ is preferable, a voltage satisfying 0.6×V₂<V₁<0.95×V₂ is more preferable, and a voltage satisfying 0.7×V₂<V₁<0.9×V₂ is further preferable.

The relationship between the first rate C₁ and the second rate C₂ is C₁<C₂, and is preferably C₁<0.7×C₂, more preferably C₁<0.5×C₂, and further preferably C₁<0.3×C₂. Specific examples of the first rate C₁ include 0.05 C, 0.1 C, and 0.2 C. Specific examples of the second rate C₂ include 0.5 C, 0.8 C, and 1 C.

Step (a-4) is a step of performing charging at a constant charging rate Cₐ₋₂ of 0.05 C or greater to a second voltage V₂. The charging rate Cₐ₋₂ is preferably 0.5 C or greater and more preferably 1 C or greater. Examples of the range of the charging rate Cₐ₋₂ include 0.5 C≤Cₐ₋₂≤15 C, 1 C≤Cₐ₋₂≤13 C, and 2 C≤Cₐ₋₂≤11 C.

In each of step (a-3) and step (a-4), after charging to the second voltage V₂ has been performed, charging for keeping the voltage is preferably performed. Examples of the second voltage V₂ keeping period include 0.5 to 5 hours and 1 to 3 hours.

Through the method for producing the lithium ion secondary battery of the present invention, the following charging/discharging control device of the present invention is understood.

A charging/discharging control device of the present invention includes a control unit for performing, on the lithium ion secondary battery, the above-described activation process including step (a), step (b), and step (c), or step (a) and step (d) in the method for producing the lithium ion secondary battery of the present invention. The charging/discharging control device of the present invention may be installed in a production facility for the lithium ion secondary battery, or maybe installed in a charging system for charging the lithium ion secondary battery before or after shipping of the lithium ion secondary battery. The charging/discharging control device of the present invention, or the production facility or the charging system preferably includes a temperature control unit which controls the temperature of the lithium ion secondary battery.

The lithium ion secondary battery of the present invention includes: a negative electrode having a negative electrode active material capable of occluding and releasing lithium ions; a positive electrode having a positive electrode active material capable of occluding and releasing lithium ions; and the electrolytic solution of the present invention.

As the negative electrode active material, a material capable of occluding and releasing lithium ions is used. Thus, the material is not limited in particular as long as the material is an elemental substance, an alloy, or a compound capable of occluding and releasing lithium ions. For example, an elemental substance from among Li, group 14 elements such as carbon, silicon, germanium, and tin, group 13 elements such as aluminum and indium, group 12 elements such as zinc and cadmium, group 15 elements such as antimony and bismuth, alkaline earth metals such as magnesium and calcium, and group 11 elements such as silver and gold may be used as the negative electrode active material. When silicon or the like is used as the negative electrode active material, a high capacity active material is obtained since a single silicon atom reacts with multiple lithium atoms. However, a problem that a significant expansion and contraction of volume is caused in association with occlusion and release of lithium may occur. Thus, in order to reduce the possibility of occurrence of the problem, an alloy or a compound obtained by combining an elemental substance of silicon or the like with another element such as a transition metal is suitably used as the negative electrode active material. Specific examples of the alloy or the compound include tin-based materials such as Ag—Sn alloys, Cu—Sn alloys, and Co—Sn alloys, carbon based materials such as various graphites, silicon based materials such as SiOₓ (0.3≤x≤1.6) that undergoes disproportionation into the elemental substance silicon and silicon dioxide, and a complex obtained by combining a carbon based material with elemental substance silicon or a silicon based material. In addition, as the negative electrode active material, an oxide such as Nb₂O₅, TiO₂, Li₄Ti₅O₁₂, WO₂, MoO₂, and Fe₂O₃, or a nitride represented by Li₃₋ₓMₓN (M═Co, Ni, Cu) may be used. With regard to the negative electrode active material, one or more types described above may be used.

A more specific example of the negative electrode active material is a graphite whose G/D ratio is not lower than 3.5. The G/D ratio is the ratio of G-band and D-band peaks in a Raman spectrum. In the Raman spectrum of graphite, G-band is observed near 1590 cm⁻¹ and D-band is observed near 1350 cm⁻¹, as peaks, respectively. G-band is derived from a graphite structure and D-band is derived from defects. Thus, having a higher G/D ratio, which is the ratio of G-band and D-band, means the graphite has higher crystallinity with fewer defects. Hereinafter, a graphite whose G/D ratio is not lower than 3.5 is sometimes referred to as a high-crystallinity graphite, and a graphite whose G/D ratio is lower than 3.5 is sometimes referred to as a low-crystallinity graphite.

As such a high-crystallinity graphite, both natural graphites and artificial graphites may be used. When a classification method based on shape is used, flake-like graphites, spheroidal graphites, block-like graphite, earthy graphites, and the like may be used. In addition, coated graphites obtained by coating the surface of a graphite with a carbon material or the like may also be used.

Examples of specific negative electrode active materials include carbon materials whose crystallite size is not larger than 20 nm, and preferably not larger than 5 nm. A larger crystallite size means that the carbon material has atoms arranged periodically and precisely in accordance with a certain rule. On the other hand, a carbon material whose crystallite size is not larger than 20 nm is considered to have atoms being in a state of poor periodicity and poor preciseness in arrangement. For example, when the carbon material is a graphite, the crystallite size becomes not larger than 20 nm when the size of a graphite crystal is not larger than 20 nm or when atoms forming the graphite are arranged irregularly due to distortion, defects, and impurities, etc.

Representative carbon materials whose crystallite size is not larger than 20 nm include hardly graphitizable carbon, which is so-called hard carbon, and easily graphitizable carbon, which is so-called soft carbon.

In order to measure the crystallite size of the carbon material, an X-ray diffraction method using CuKα radiation as an X-ray source may be used. With the X-ray diffraction method, the crystallite size is calculated using the following Scherrer's equation on the basis of a half width of a diffraction peak detected at a diffraction angle of 2θ=20 degrees to 30 degrees and the diffraction angle.

L=0.94 λ/(β cos θ)

where

L: crystallite size

λ: incident X-ray wavelength (1.54 angstrom)

β: half width of peak (radian)

θ: diffraction angle.

Specific examples of the negative electrode active material include materials containing silicon. A more specific example is SiOₓ (0.3≤x≤1.6) disproportionated into two phases of Si phase and silicon oxide phase. The Si phase in SiOₓ is capable of occluding and releasing lithium ions, and changes in volume associated with charging and discharging of the secondary battery. The silicon oxide phase changes less in volume associated with charging and discharging when compared to the Si phase. Thus, SiOₓ as the negative electrode active material achieves higher capacity because of the Si phase, and when the silicon oxide phase is included, suppresses change in volume of the entirety of the negative electrode active material. When “x” becomes smaller than a lower limit value, cycle characteristics of the secondary battery deteriorate since the change in volume during charging and discharging becomes too large due to the ratio of Si becoming excessive. On the other hand, if “x” becomes larger than an upper limit value, energy density is decreased due to the Si ratio being too small. The range of “x” is more preferably 0.5≤x≤1.5, and further preferably 0.7≤x≤1.2.

In SiOₓ described above, an alloying reaction between lithium and silicon in the Si phase is considered to occur during charging and discharging of the lithium ion secondary battery. This alloying reaction is considered to contribute to charging and discharging of the lithium ion secondary battery. Also in the negative electrode active material including tin described later, charging and discharging are considered to occur by an alloying reaction between tin and lithium.

Specific examples of the negative electrode active material include materials containing tin. More specific examples include Sn elemental substance, tin alloys such as Cu-Sn and Co-Sn, amorphous tin oxides, and tin silicon oxides. Examples of the amorphous tin oxides include SnB_{0.4}P_{0.6}O_{3.1}, and examples of the tin silicon oxides include SnSiO₃.

The material containing silicon and the material containing tin described above are each preferably made into a composite with a carbon material to be used as the negative electrode active material. By using those materials as a composite, the structure particularly of silicon and/or tin is stabilized, and durability of the negative electrode is improved. Making a composite mentioned above may be performed by a known method. As the carbon material used in the composite, a graphite, a hard carbon, a soft carbon, etc. may be used. The graphite may be a natural graphite or an artificial graphite.

Specific examples of the negative electrode active material include lithium titanate having a spinel structure such as Li₄₊ₓTi_{5+y}O₁₂ (−1≤x≤4, −1≤y≤1) and lithium titanate having a ramsdellite structure such as Li₂Ti₃O₇.

Specific examples of the negative electrode active material include graphites having a value of long axis/short axis of 1 to 5, and preferably 1 to 3. Here, the long axis means the length of the longest portion of a graphite particle. The short axis means the longest length in directions perpendicular to the long axis. Spheroidal graphites and meso carbon micro beads correspond to the graphite. The spheroidal graphites mean carbon materials which are artificial graphite, natural graphite, easily graphitizable carbon, and hardly graphitizable carbon, for example, and which have spheroidal or substantially spheroidal shapes.

Spheroidal graphite is obtained by grinding graphite into flakes by means of an impact grinder having a relatively small crushing force and by compressing and spheroidizing the flakes. Examples of the impact grinder include a hammer mill and a pin mill. The above operation is preferably performed with the outer-circumference line speed of the hammer or the pin of the mill set at about 50 to 200 m/s. Supply and ejection of graphite with respect to such mills are preferably performed in association with a current of air or the like.

The graphite is preferably have a BET specific surface area in a range of 0.5 to 15 m²/g, and more preferably in a range of 4 to 12 m²/g. When the BET specific surface area is too large, side reaction between the graphite and the electrolytic solution is accelerated in some cases. When the BET specific surface area is too small, reaction resistance of the graphite becomes large in some cases.

The mean particle diameter of the graphite is preferably in a range of 2 to 30 μm, and more preferably in a range of 5 to 20 μm. The mean particle diameter means D50 measured by a general laser diffraction scattering type particle size distribution measuring device.

The negative electrode includes a current collector, and a negative electrode active material layer bound to the surface of the current collector.

The current collector refers to an electron conductor that is chemically inert for continuously sending a flow of current to the electrode during discharging or charging of the lithium ion secondary battery. Examples of the current collector include at least one selected from silver, copper, gold, aluminum, tungsten, cobalt, zinc, nickel, iron, platinum, tin, indium, titanium, ruthenium, tantalum, chromium, or molybdenum, and metal materials such as stainless steel. The current collector may be coated with a known protective layer. One obtained by treating the surface of the current collector with a known method may be used as the current collector.

The current collector takes forms such as a foil, a sheet, a film, a line shape, a bar shape, and a mesh. Thus, as the current collector, for example, metal foils such as copper foil, nickel foil, aluminum foil, and stainless steel foil are suitably used. When the current collector is in the form of a foil, a sheet, or a film, the thickness thereof is preferably in a range of 1 μm to 100 μm.

The negative electrode active material layer includes a negative electrode active material, and, if necessary, a binding agent and/or a conductive additive.

The binding agent serves to adhere the active material, the conductive additive, or the like, to the surface of the current collector.

As the binding agent, a known binding agent may be used such as a fluorine-containing resin such as polyvinylidene fluoride, polytetrafluoroethylene, or fluororubber, a thermoplastic resin such as polypropylene or polyethylene, an imide based resin such as polyimide or polyamide-imide, an alkoxysilyl group-containing resin, or a styrene-butadiene rubber.

In addition, a polymer having a hydrophilic group may be used as the binding agent. The secondary battery of the present invention provided with a polymer having a hydrophilic group as the binding agent more suitably maintains the capacity thereof. Examples of the hydrophilic group of the polymer having a hydrophilic group include carboxyl group, sulfa group, silanol group, amino group, hydroxyl group, and phosphoric acid based group such as phosphoric acid group. Among those described above, a polymer containing a carboxyl group in the molecule thereof, such as polyacrylic acid, carboxymethyl cellulose, and polymethacrylic acid, or a polymer containing a sulfo group such as poly(p-styrenesulfonic acid) is preferable.

A polymer containing a large number of carboxyl groups and/or sulfo groups, such as polyacrylic acid or a copolymer of acrylic acid and vinylsulfonic acid, is water soluble. The polymer containing the hydrophilic group is preferably a water soluble polymer, and is preferably a polymer containing multiple carboxyl groups and/or sulfo groups in a single molecule thereof in terms of the chemical structure.

A polymer containing a carboxyl group in the molecule thereof is produced through, for example, a method of polymerizing an acid monomer or a method of imparting a carboxyl group to a polymer. Examples of the acid monomer include acid monomers having one carboxyl group in respective molecules such as acrylic acid, methacrylic acid, vinylbenzoic acid, crotonic acid, pentenoic acid, angelic acid, and tiglic acid, and acid monomers having two or more carboxyl groups in respective molecules such as itaconic acid, mesaconic acid, citraconic acid, fumaric acid, maleic acid, 2-pentenedioic acid, methylenesuccinic acid, allylmalonic acid, isopropylidene succinic acid, 2,4-hexadienedioic acid, and acetylene dicarboxylic acid.

A copolymer obtained through polymerization of two or more types of acid monomers selected from the acid monomers described above may be used as the binding agent.

For example, as disclosed in JP2013065493 (A), a polymer that includes in the molecule thereof an acid anhydride group formed through condensation of carboxyl groups of a copolymer of acrylic acid and itaconic acid is also preferably used as the binding agent. Since the binding agent has a structure derived from a monomer with high acidity by having two or more carboxyl groups in a single molecule thereof, the binding agent is considered to easily trap the lithium ions and the like before a degradation reaction of the electrolytic solution occurs during charging. Furthermore, although the polymer has an increased acidity because the polymer has more carboxyl groups per monomer when compared to polyacrylic acid and polymethacrylic acid, the acidity is not increased too much because a certain amount of carboxyl groups have changed into acid anhydride groups. Therefore, the secondary battery having the negative electrode using the polymer as the binding agent has improved initial efficiency and improved input-output characteristics.

The blending ratio of the binding agent in the negative electrode active material layer in mass ratio is preferably negative electrode active material: binding agent=1:0.005 to 1:0.3. The reason is that when too little of the binding agent is contained, moldability of the electrode deteriorates, whereas too much of the binding agent is contained, energy density of the electrode becomes low.

The conductive additive is added for increasing conductivity of the electrode. Thus, the conductive additive is preferably added optionally when conductivity of the electrode is insufficient, and does not have to be added when conductivity of the electrode is sufficiently good. As the conductive additive, a fine electron conductor that is chemically inert may be used, and examples thereof include carbonaceous fine particles such as carbon black, graphite, acetylene black, Ketchen black (registered trademark), vapor grown carbon fiber, and various metal particles. With regard to the conductive additive described above, a single type by itself, or a combination of two or more types may be added to the active material layer. The blending ratio of the conductive additive in the negative electrode active material layer in mass ratio is preferably negative electrode active material: conductive additive=1:0.01 to 1:0.5. The reason is that when too little of the conductive additive is contained, efficient conducting paths are not formed, whereas when too much of the conductive additive is contained, moldability of the negative electrode active material layer deteriorates and energy density of the electrode becomes low.

The positive electrode used in the lithium ion secondary battery includes a positive electrode active material capable of occluding and releasing lithium ions. The positive electrode includes a current collector and a positive electrode active material layer bound to the surface of the current collector. The positive electrode active material layer includes a positive electrode active material, and, if necessary, a binding agent and/or a conductive additive. The current collector of the positive electrode is not limited in particular as long as the current collector is a metal capable of withstanding a voltage suited for the active material that is used. Examples of the current collector include at least one selected from silver, copper, gold, aluminum, tungsten, cobalt, zinc, nickel, iron, platinum, tin, indium, titanium, ruthenium, tantalum, chromium, and molybdenum, and metal materials such as stainless steel.

When the potential of the positive electrode is set to not lower than 4V using lithium as reference, aluminum is preferably used as the current collector.

Specifically, as the positive electrode current collector, one formed from aluminum or an aluminum alloy is preferably used. Here, aluminum refers to pure aluminum, and an aluminum whose purity is not less than 99.0% is referred to as pure aluminum. An alloy obtained by adding various elements to pure aluminum is referred to as an aluminum alloy. Examples of the aluminum alloy include those that are Al—Cu based, Al—Mn based, Al—Fe based, Al—Si based, Al—Mg based, Al—Mg—Si based, and Al—Zn—Mg based.

In addition, specific examples of aluminum or the aluminum alloy include A1000 series alloys (pure aluminum based) such as JIS A1085, A1N30, etc., A3000 series alloys (Al—Mn based) such as JIS A3003, A3004, etc., and A8000 series alloys (Al—Fe based) such as JIS A8079, A8021, etc.

The current collector may be coated with a known protective layer. One obtained by treating the surface of the current collector with a known method may be used as the current collector.

The current collector takes forms such as a foil, a sheet, a film, a line shape, a bar shape, and a mesh. Thus, as the current collector, for example, metal foils such as copper foil, nickel foil, aluminum foil, and stainless steel foil are suitably used. When the current collector is in the form of a foil, a sheet, or a film, the thickness thereof is preferably in a range of 1 μm to 100 μm.

As the binding agent and the conductive additive for the positive electrode, those described with respect to the negative electrode are used at similar blending ratios.

Examples of the positive electrode active material include layer compounds that are LiₐNi_{b}Co_{c}Mn_{d}DₑO_{f} (0.2≤a≤1.2; b+c+d+e=1; 0≤e<1; D is at least one element selected from Li, Fe, Cr, Cu, Zn, Ca, Mg, S, Si, Na, K, Al, Zr, Ti, P, Ga, Ge, V, Mo, Nb, W, or La; 1.7≤f≤2.1) and Li₂MnO₃. Additional examples of the positive electrode active material include metal oxides having a spinel structure such as LiMn₂O₄, a solid solution formed from a mixture of a metal oxide having a spinel structure and a layer compound, and polyanion based compounds represented by LiMPO₄, LiMVO₄, Li₂MSiO₄ (where “M” is selected from at least one of Co, Ni, Mn, or Fe), or the like. Further additional examples of the positive electrode active material include tavorite based compounds represented by LiMPO₄F (“M” is a transition metal) such as LiFePO₄F and borate based compounds represented by LiMBO₃ (“M” is a transition metal) such as LiFeBO₃. Any metal oxide used as the positive electrode active material may have a basic composition of the composition formulae described above, and those in which a metal element included in the basic composition is substituted with another metal element may also be used. In addition, as the positive electrode active material, one that does not contain a charge carrier (e.g., a lithium ion contributing to the charging and discharging) may also be used. For example, elemental substance sulfur (S), a compound that is a composite of sulfur and carbon, metal sulfides such as TiS₂, oxides such as V₂O₅ and MnO₂, polyaniline and anthraquinone and compounds containing such aromatics in the chemical structure, conjugate based materials such as conjugate diacetic acid based organic matters, and known other materials may be used. Furthermore, a compound having a stable radical such as nitroxide, nitronyl nitroxide, galvinoxyl, and phenoxyl may be used as the positive electrode active material. When a positive electrode active material not containing a charge carrier such as lithium is to be used, a charge carrier has to be added in advance to the positive electrode and/or the negative electrode using a known method. The charge carrier may be added in an ionic state, or may be added in a nonionic state such as a metal. For example, when the charge carrier is lithium, a lithium foil may be pasted to and integrated with the positive electrode and/or the negative electrode.

Specific examples of the positive electrode active material include LiNi_{0.5}Co_{0.2}Mn_{0.3}O₂, LiNi_{1/3}Co_{1/3}Mn_{1/3}O₂, LiNi_{0.5}Mn_{0.5}O₂, LiNi_{0.75}Co_{0.1}Mn_{0.15}O₂, LiMnO₂, LiNiO₂, and LiCoO₂ having a layered rock salt structure. Another specific example of the positive electrode active material is Li₂MnO₃—LiCoO₂.

Specific examples of the positive electrode active material include LiₓA_{y}Mn_{2-y}O₄ having a spinel structure (“A” is at least one element selected from Ca, Mg, S, Si, Na, K, Al, P, Ga, or Ge, and/or at least one type of metal element selected from transition metal elements, 0<x≤2.2, 0≤y≤1). More specific examples include LiMn₂O₄, and LiNi_{0.5}Mn_{1.5}O₄.

Specific examples of the positive electrode active material include LiFePO₄, Li₂FeSiO₄, LiCoPO₄, Li₂CoPO₄, Li₂MnPO₄, Li₂MnSiO₄, and Li₂CoPO₄F.

In order to form the active material layer on the surface of the current collector, the active material may be applied on the surface of the current collector using a known conventional method such as roll coating method, die coating method, dip coating method, doctor blade method, spray coating method, and curtain coating method. Specifically, an active material layer forming composition containing the active material and, if necessary, the binding agent and the conductive additive, is prepared, and, after adding a suitable solvent to this composition to obtain a paste, the paste is applied on the surface of the current collector and then dried. Examples of the solvent include N-methyl-2-pyrrolidone, methanol, methyl isobutyl ketone, and water. In order to increase electrode density, compression may be performed after drying.

A separator is used in the lithium ion secondary battery, if necessary. The separator is for separating the positive electrode and the negative electrode to allow passage of lithium ions while preventing short circuit due to a contact of both electrodes. As the separator, one that is known may be used. Examples of the separator include porous materials, nonwoven fabrics, and woven fabrics using one or more types of materials having electrical insulation property such as: synthetic resins such as polytetrafluoroethylene, polypropylene, polyethylene, polyimide, polyamide, polyaramide (aromatic polyamide), polyester, and polyacrylonitrile; polysaccharides such as cellulose and amylose; natural polymers such as fibroin, keratin, lignin, and suberin; and ceramics. In addition, the separator may have a multilayer structure.

A specific method for producing the lithium ion secondary battery of the present invention is described.

An electrode assembly is formed from the positive electrode, the negative electrode, and, if necessary, the separator interposed therebetween. The electrode assembly may be a laminated type obtained by stacking the positive electrode, the separator, and the negative electrode, or a wound type obtained by winding the positive electrode, the separator, and the negative electrode. The lithium ion secondary battery is preferably formed by respectively connecting, using current collecting leads or the like, the positive electrode current collector to a positive electrode external connection terminal and the negative electrode current collector to a negative electrode external connection terminal, and then adding the electrolytic solution of the present invention to the electrode assembly. In addition, the lithium ion secondary battery of the present invention preferably executes charging and discharging in a voltage range suitable for the types of active materials contained in the electrodes

The form of the lithium ion secondary battery of the present invention is not limited in particular, and various forms such as a cylindrical type, a square type, a coin type, a laminated type, etc., are used.

The lithium ion secondary battery of the present invention may be mounted on a vehicle. The vehicle may be a vehicle that uses, as all or one portion of the source of power, electrical energy obtained from the lithium ion secondary battery, and examples thereof include electric vehicles and hybrid vehicles. When the lithium ion secondary battery is to be mounted on the vehicle, a plurality of the lithium ion secondary batteries may be connected in series to form an assembled battery. Other than the vehicles, examples of instruments on which the lithium ion secondary battery may be mounted include various home appliances, off ice instruments, and industrial instruments driven by a battery such as personal computers and portable communication devices. In addition, the lithium ion secondary battery of the present invention may be used as power storage devices and power smoothing devices for wind power generation, photovoltaic power generation, hydroelectric power generation, and other power systems, power supply sources for auxiliary machineries and/or power of ships, etc., power supply sources for auxiliary machineries and/or power of aircraft and spacecraft, etc., auxiliary power supply for vehicles that do not use electricity as a source of power, power supply for movable household robots, power supply for system backup, power supply for uninterruptible power supply devices, and power storage devices for temporarily storing power required for charging at charge stations for electric vehicles.

A capacitor of the present invention including the electrolytic solution of the present invention may be formed by replacing, with active carbon or the like that is used as a polarized electrode material, a part or all of the negative electrode active material or the positive electrode active material, or a part or all of the negative electrode active material and the positive electrode active material, in the lithium ion secondary battery of the present invention described above. Examples of the capacitor of the present invention include electrical double layer capacitors and hybrid capacitors such as lithium ion capacitors. As the description of the capacitor of the present invention, the description of the lithium ion secondary battery of the present invention above in which “lithium ion secondary battery” is replaced by “capacitor” as appropriate is used.

Although embodiments of the electrolytic solution of the present invention have been described above, the present invention is not limited to the embodiments. Without departing from the gist of the present invention, the present invention can be implemented in various modes with modifications and improvements, etc., that can be made by a person skilled in the art.

### EXAMPLES

In the following, the present invention is described specifically by presenting Examples and Comparative Examples. The present invention is not limited to these Examples.

### Production Example 1-1

(FSO₂)₂NLi was dissolved in dimethyl carbonate, whereby an electrolytic solution of Production Example 1-1 containing (FSO₂)₂NLi at a concentration of 4.5 mol/L was produced. In the electrolytic solution of Production Example 1-1, the organic solvent is contained at a mole ratio of 1.6 relative to the lithium salt.

### Production Example 1-2

(FSO₂)₂NLi was dissolved in dimethyl carbonate, whereby an electrolytic solution of Production Example 1-2 containing (FSO₂)₂NLi at a concentration of 3.9 mol/L was produced. In the electrolytic solution of Production Example 1-2, the organic solvent is contained at a mole ratio of 2 relative to the metal salt.

### Production Example 1-3

(FSO₂)2NLi was dissolved in dimethyl carbonate, whereby an electrolytic solution of Production Example 1-3 containing (FSO₂)₂NLi at a concentration of 3.0 mol/L was produced. In the electrolytic solution of Production Example 1-3, the organic solvent is contained at a mole ratio of 3 relative to the lithium salt.

### Production Example 1-4

(FSO₂)₂NLi was dissolved in dimethyl carbonate, whereby an electrolytic solution of Production Example 1-4 containing (FSO₂)₂NLi at a concentration of 2.7 mol/L was produced. In the electrolytic solution of Production Example 1-4, the organic solvent is contained at a mole ratio of 3.5 relative to the lithium salt.

### Production Example 1-5

(FSO₂)₂NLi was dissolved in dimethyl carbonate, whereby an electrolytic solution of Production Example 1-5 containing (FSO₂)₂NLi at a concentration of 2.4 mol/L was produced. In the electrolytic solution of Production Example 1-5, the organic solvent is contained at a mole ratio of 4 relative to the lithium salt.

### Production Example 1-6

(FSO₂)₂NLi was dissolved in dimethyl carbonate, whereby an electrolytic solution of Production Example 1-6 containing (FSO₂)₂NLi at a concentration of 2.0 mol/L was produced. In the electrolytic solution of Production Example 1-6, the organic solvent is contained at a mole ratio of 5 relative to the lithium salt.

### Production Example 1-7

(FSO₂)₂NLi was dissolved in dimethyl carbonate, whereby an electrolytic solution of Production Example 1-7 containing (FSO₂)₂NLi at a concentration of 1.0 mol/L was produced. In the electrolytic solution of Production Example 1-7, the organic solvent is contained at a mole ratio of 11 relative to the metal salt.

### Production Example 2-1

(FSO₂)₂NLi was dissolved in a mixed solvent obtained by mixing dimethyl carbonate and diethyl carbonate at a mole ratio of 9:1, whereby an electrolytic solution of Production Example 2-1 containing (FSO₂)₂NLi at a concentration of 2.9 mol/L was produced. In the electrolytic solution of Production Example 2-1, the organic solvent is contained at a mole ratio of 3 relative to the lithium salt.

### Production Example 2-2

(FSO₂)₂NLi was dissolved in a mixed solvent obtained by mixing dimethyl carbonate and diethyl carbonate at a mole ratio of 7:1, whereby an electrolytic solution of Production Example 2-2 containing (FSO₂)₂NLi at a concentration of 2.9 mol/L was produced. In the electrolytic solution of Production Example 2-2, the organic solvent is contained at a mole ratio of 3 relative to the lithium salt.

### Production Example 2-3

(FSO₂)₂NLi was dissolved in a mixed solvent obtained by mixing dimethyl carbonate and diethyl carbonate at a mole ratio of 9:1, whereby an electrolytic solution of Production Example 2-3 containing (FSO₂)₂NLi at a concentration of 2.4 mol/L was produced. In the electrolytic solution of Production Example 2-3, the organic solvent is contained at a mole ratio of 4 relative to the lithium salt.

### Production Example 3

(FSO₂)₂NLi was dissolved in a mixed solvent obtained by mixing dimethyl carbonate and propylene carbonate at a mole ratio of 7:1, whereby an electrolytic solution of Production Example 3 containing (FSO₂)₂NLi at a concentration of 3.0 mol/L was produced. In the electrolytic solution of Production Example 3, the organic solvent is contained at a mole ratio of 3 relative to the lithium salt.

### Production Example 4

(FSO₂)₂NLi was dissolved in a mixed solvent obtained by mixing dimethyl carbonate and ethylene carbonate at a mole ratio of 7:1, whereby an electrolytic solution of Production Example 4 containing (FSO₂)₂NLi at a concentration of 3.0 mol/L was produced. In the electrolytic solution of Production Example 4, the organic solvent is contained at a mole ratio of 3.1 relative to the lithium salt.

### Production Example 5

(FSO₂)₂NLi was dissolved in ethyl methyl carbonate, whereby an electrolytic solution of Production Example 5 containing (FSO₂)₂NLi at a concentration of 2.2 mol/L was produced. In the electrolytic solution of Production Example 5, the organic solvent is contained at a mole ratio of 3.5 relative to the lithium salt.

### Production Example 6

(FSO₂)₂NLi was dissolved in diethyl carbonate, whereby an electrolytic solution of Production Example 6 containing (FSO₂)₂NLi at a concentration of 2.0 mol/L was produced. In the electrolytic solution of Production Example 6, the organic solvent is contained at a mole ratio of 3.5 relative to the lithium salt.

### Production Example 7-1

(FSO₂)₂NLi was dissolved in a mixed solvent obtained by mixing dimethyl carbonate and ethyl methyl carbonate at a mole ratio of 9:1, whereby an electrolytic solution of Production Example 7-1 containing (FSO₂)₂NLi at a concentration of 2.9 mol/L was produced. In the electrolytic solution of Production Example 7-1, the organic solvent is contained at a mole ratio of 3 relative to the lithium salt.

### Production Example 7-2

(FSO₂)₂NLi was dissolved in a mixed solvent obtained by mixing dimethyl carbonate and ethyl methyl carbonate at a mole ratio of 9:1, whereby an electrolytic solution of Production Example 7-2 containing (FSO₂)₂NLi at a concentration of 2.6 mol/L was produced. In the electrolytic solution of Production Example 7-2, the organic solvent is contained at a mole ratio of 3.6 relative to the lithium salt.

### Production Example 8-1

Vinylene carbonate serving as the unsaturated cyclic carbonate and (FSO₂)₂NLi were dissolved in a mixed solvent obtained by mixing dimethyl carbonate and ethyl methyl carbonate each serving as the linear carbonate at a mole ratio of 9:1, whereby an electrolytic solution of Production Example 8-1 containing (FSO₂)₂NLi at a concentration of 2.4 mol/L and vinylene carbonate by 0.13 mass % was produced. In the electrolytic solution of Production Example 8-1, the linear carbonate is contained at a mole ratio of 4 relative to (FSO₂)₂NLi.

### Production Example 8-2

An electrolytic solution of Production Example 8-2 was produced using a method similar to that in Production Example 8-1 except for increasing the added amount of vinylene carbonate such that vinylene carbonate is contained by 0.63 mass %.

### Production Example 8-3

An electrolytic solution of Production Example 8-3 was produced using a method similar to that in Production Example 8-1 except for increasing the added amount of vinylene carbonate such that vinylene carbonate is contained by 1.3 mass %.

### Production Example 8-4

An electrolytic solution of Production Example 8-4 was produced using a method similar to that in Production Example 8-1 except for increasing the added amount of vinylene carbonate such that vinylene carbonate is contained by 2.5 mass %.

### Production Example 8-5

An electrolytic solution of Production Example 8-5 was produced using a method similar to that in Production Example 8-1 except for increasing the added amount of vinylene carbonate such that vinylene carbonate is contained by 6.3 mass %.

### Production Example 9-1

An electrolytic solution of Production Example 9-1 was produced using a method similar to that in Production Example 8-1 except for not adding vinylene carbonate.

### Production Example 9-2

An electrolytic solution of Production Example 9-2 was produced using a method similar to that in Production Example 8-2 except for decreasing the added amount of (FSO₂)₂NLi such that the concentration of (FSO₂)₂NLi is 1.0 mol/L.

### Production Example 9-3

An electrolytic solution of Production Example 9-3 was produced using a method similar to that in Production Example 8-2 except for increasing the added amount of (FSO₂)₂NLi such that the concentration of (FSO₂)₂NLi is 3.9 mol/L.

### Comparative Production Example 1-1

LiPF₆ was dissolved in a mixed solvent obtained by mixing dimethyl carbonate and ethyl methyl carbonate serving as the linear carbonate and ethylene carbonate serving as the cyclic carbonate at a volume ratio of 4:3:3, whereby an electrolytic solution of Comparative Production Example 1-1 containing LiPF₆ at a concentration of 1.0 mol/L was produced. The electrolytic solution of Comparative Production Example 1-1 is a conventional general electrolytic solution, and the mole ratio of the organic solvent relative to LiPF₆ is approximately 10.

### Comparative Production Example 1-2

Vinylene carbonate serving as the unsaturated cyclic carbonate and LiPF₆ were dissolved in a mixed solvent obtained by mixing dimethyl carbonate and ethyl methyl carbonate serving as the linear carbonate and ethylene carbonate serving as the cyclic carbonate at a volume ratio of 4:3:3, whereby an electrolytic solution of Comparative Production Example 1-2 containing LiPF₆ at a concentration of 1.0 mol/L and vinylene carbonate by 0.5 masso was produced.

### Comparative Production Example 1-3

An electrolytic solution of Comparative Production Example 1-3 was produced using a method similar to that in Comparative Production Example 1-2 except for increasing the added amount of LiPF₆ such that the concentration of LiPF₆ is 1.8 mol/L.

Table 1-1 and Table 1-2 show the list of the electrolytic solutions of Production Examples and Comparative Production Examples.

TABLE 1-1

| | | | Number of | |
|---|---|---|---|---|
| | | | moles of | |
| | | | organic solvent/ | |
| | | | number of | Metal salt |
| | Lithium | Organic | moles of | concentration |
| | salt | solvent | lithium salt | (mol/L) |
| Production | LiFSA | DMC | 1.6 | 4.5 |
| Example 1-1 | | | | |
| Production | LiFSA | DMC | 2 | 3.9 |
| Example 1-2 | | | | |
| Production | LiFSA | DMC | 3 | 3.0 |
| Example 1-3 | | | | |
| Production | LiFSA | DMC | 3.5 | 2.7 |
| Example 1-4 | | | | |
| Production | LiFSA | DMC | 4 | 2.4 |
| Example 1-5 | | | | |
| Production | LiFSA | DMC | 5 | 2.0 |
| Example 1-6 | | | | |
| Production | LiFSA | DMC | 10 | 1.0 |
| Example 1-7 | | | | |
| Production | LiFSA | DMC and | 3 | 2.9 |
| Example 2-1 | | DEC mole | | |
| | | ratio 9:1 | | |
| Production | LiFSA | DMC and | 3 | 2.9 |
| Example 2-2 | | DEC mole | | |
| | | ratio 7:1 | | |
| Production | LiFSA | DMC and | 4 | 2.4 |
| Example 2-3 | | DEC mole | | |
| | | ratio 9:1 | | |
| Production | LiFSA | DMC and | 3 | 3.0 |
| Example 3 | | PC mole | | |
| | | ratio 7:1 | | |
| Production | LiFSA | DMC and | 3.1 | 3.0 |
| Example 4 | | EC mole | | |
| | | ratio 7:1 | | |
| Production | LiFSA | EMC | 3.5 | 2.2 |
| Example 5 | | | | |
| Production | LiFSA | DEC | 3.5 | 2.0 |
| Example 6 | | | | |
| Production | LiFSA | DMC and | 3 | 2.9 |
| Example 7-1 | | EMC mole | | |
| | | ratio 9:1 | | |
| Production | LiFSA | DMC and | 3.6 | 2.6 |
| Example 7-2 | | EMC mole | | |
| | | ratio 9:1 | | |

TABLE 1-2

| | | | Number of | | |
|---|---|---|---|---|---|
| | | | moles of | | |
| | | | organic | Metal | Mass % |
| | | | solvent/ | salt | of unsat- |
| | | | number of | concen- | urated |
| | Metal | Organic | moles of | tration | cyclic |
| | salt | solvent | metal salt | (mol/L) | carbonate |
| Production | LiFSA | DMC and | 4 | 2.4 | 0.13 |
| Example 8-1 | | EMC mole | | | |
| | | ratio 9:1 | | | |
| Production | LiFSA | DMC and | 4 | 2.4 | 0.63 |
| Example 8-2 | | EMC mole | | | |
| | | ratio 9:1 | | | |
| Production | LiFSA | DMC and | 4 | 2.4 | 1.3 |
| Example 8-3 | | EMC mole | | | |
| | | ratio 9:1 | | | |
| Production | LiFSA | DMC and | 4 | 2.4 | 2.5 |
| Example 8-4 | | EMC mole | | | |
| | | ratio 9:1 | | | |
| Production | LiFSA | DMC and | 4 | 2.4 | 6.3 |
| Example 8-5 | | EMC mole | | | |
| | | ratio 9:1 | | | |
| Production | LiFSA | DMC and | 4 | 2.4 | 0 |
| Example 9-1 | | EMC mole | | | |
| | | ratio 9:1 | | | |
| Production | LiFSA | DMC and | | 1.0 | 0.63 |
| Example 9-2 | | EMC mole | | | |
| | | ratio 9:1 | | | |
| Production | LiFSA | DMC and | | 3.9 | 0.63 |
| Example 9-3 | | EMC mole | | | |
| | | ratio 9:1 | | | |
| Comparative | LiPF₆ | DMC, EMC, | 10 | 1.0 | 0 |
| Production | | and EC volume | | | |
| Example 1-1 | | ratio 4:3:3 | | | |
| Comparative | LiPF₆ | DMC, EMC, | 10 | 1.0 | 0.5 |
| Production | | and EC volume | | | |
| Example 1-2 | | ratio 4:3:3 | | | |
| Comparative | LiPF₆ | DMC, EMC, | | 1.8 | 0.5 |
| Production | | and EC volume | | | |
| Example 1-3 | | ratio 4:3:3 | | | |

The meanings of abbreviations in Table 1-1 and Table 1-2 are as follows.

LiFSA: (FSO₂)₂NLi

DMC: dimethyl carbonate

EMC: ethyl methyl carbonate

DEC: diethyl carbonate

PC: propylene carbonate

EC: ethylene carbonate

### Example I

A lithium ion secondary battery of Example I including the electrolytic solution of Production Example 7-2 was produced in the following manner.

90 parts by mass of Li_{1.1}Ni_{5/10}Co_{3/10}Mn_{2/10}O₂ serving as the positive electrode active material, 8 parts by mass of acetylene black serving as the conductive additive, and 2 parts by mass of polyvinylidene fluoride serving as the binding agent were mixed. This mixture was dispersed in a proper amount of N-methyl-2-pyrrolidone to create a slurry. As the positive electrode current collector, an aluminum foil corresponding to JIS A1000 series and having a thickness of 15 μm was prepared. The slurry was applied in a film form on the surface of the aluminum foil by using a doctor blade. The aluminum foil on which the slurry was applied was dried for 20 minutes at 80° C. to remove N-methyl-2-pyrrolidone. Then, the aluminum foil was pressed to obtain a joined object. The obtained joined object was heated and dried in a vacuum dryer for 6 hours at 120° C. to obtain an aluminum foil having a positive electrode active material layer formed thereon. This was used as the positive electrode. The positive electrode active material layer was formed on the positive electrode current collector at 5.5 mg/cm² per unit area of the applied surface. The density of the positive electrode active material layer was 2.5 g/cm³.

98 parts bymass of spheroidal graphite serving as the negative electrode active material, and 1 part by mass of styrene-butadiene-rubber and 1 part by mass of carboxymethyl cellulose, which both served as the binding agent, were mixed. This mixture was dispersed in a proper amount of ion exchanged water to create a slurry. As the negative electrode current collector, a copper foil having a thickness of 10 μm was prepared. The slurry was applied in a film form on the surface of the copper foil by using a doctor blade. The copper foil on which the slurry was applied was dried to remove water. Then, the copper foil was pressed to obtain a joined object. The obtained joined object was heated and dried in a vacuum dryer for 6 hours at 100° C. to obtain a copper foil having a negative electrode active material layer formed thereon. This was used as the negative electrode. The negative electrode active material layer was formed on the negative electrode current collector at 3.9 mg/cm² per unit area of the applied surface. The density of the negative electrode active material layer was 1.2 g/cm³.

As the separator, a porous film made from polypropylene and having a thickness of 20 μm was prepared.

An electrode assembly was formed by sandwiching the separator between the positive electrode and the negative electrode. The electrode assembly was covered with a set of two sheets of a laminate film. The laminate film was formed into a bag-like shape by having three sides thereof sealed, and the electrolytic solution of Production Example 7-2 was poured into the laminate film. Four sides were sealed airtight by sealing the remaining one side to obtain a lithium ion secondary battery in which the electrode assembly and the electrolytic solution were sealed.

The following activation process was performed on the obtained lithium ion secondary battery.

Step (a)

With respect to the lithium ion secondary battery, charging was performed up to 4.10 V at 1 C, and then 4.10 V was kept for 1 hour at 25° C.

Step (b)

With respect to the lithium ion secondary battery having been subjected to step (a), discharging was performed down to 3 V at 1 C, and then 3 V was kept for 1 hour at 25° C.

Step (c)

With respect to the lithium ion secondary battery having been subjected to step (b), charging and discharging was performed at 2 C at 60° C., between 3.3 V and4.1 V. The lithium ion secondary battery for which the above charging and discharging had been repeated 29 times was used as the lithium ion secondary battery of Example I.

### Example II

A lithium ion secondary battery of Example II was produced using a method similar to that in Example I except for setting the charging rate in step (a) to 5 C.

### Example III

A lithium ion secondary battery of Example III was produced using a method similar to that in Example I except for setting the charging rate in step (a) to 10 C.

### Example IV

A lithium ion secondary battery of Example IV was produced using a method similar to that in Example II except that the following step (d) was performed instead of step (b) and step (c).

Step (d)

The lithium ion secondary battery having been subjected to step (a) was stored at naturally occurring voltage for 2 hours at 80° C.

### Example V

A lithium ion secondary battery of Example V was produced using a method similar to that in Example I except that the following step (d) was performed after step (c).

Step (d)

With respect to the lithium ion secondary battery having been subjected to step (c), charging was performed up to 3.65 V at 25° C., and then, the lithium ion secondary battery was stored at naturally occurring voltage for 1 hour at 100° C.

### Comparative Example I

A lithium ion secondary battery of Comparative Example I was produced using a method similar to that in Example I except that the following step (a′) was performed instead of step (a) and that the temperature in step (c) was set to 25° C.

Step (a′)

With respect to the lithium ion secondary battery, charging was performed up to 3.52 V at 0.1 C, and then charging was performed up to 4.10 V at 0.8 C. Then, 4.10 V was kept for 2.48 hours at 25° C.

### Comparative Example II

A lithium ion secondary battery of Comparative Example II was produced using a method similar to that in Comparative Example I except that the temperature in step (a′) was set to 60° C., the temperature in step (b) was set to 60° C., and the temperature in step (c) was set to 60° C.

### Comparative Example III

A lithium ion secondary battery of Comparative Example III was produced using a method similar to that in Comparative Example I except for setting the temperature in step (c) to 60° C.

### Comparative Example IV

A lithium ion secondary battery of Comparative Example IV was produced using a method similar to that in Comparative Example I except that the following step (d) was performed instead of step (b) and step (c).

Step (d)

The lithium ion secondary battery having been subjected to step (a′) was stored at naturally occurring voltage for 20 hours at 60° C.

### Comparative Example V

A lithium ion secondary battery of Comparative Example V was produced using a method similar to that in Example I except that a general activation process 1 described below was performed as the activation process for the lithium ion secondary battery.

General Activation Process 1

With respect to the lithium ion secondary battery, charging was performed up to 4.10 V at 0.1 C, and then, the voltage was kept for 1 hour for 25° C. Then, discharging was performed down to 3 V at 0.1C, and then, the voltage was kept for 1 hour at 25° C.

### Comparative Example VI

A lithium ion secondary battery of Comparative Example VI was produced using a method similar to that in Example I except that a general activation process 2 described below was performed as the activation process for the lithium ion secondary battery.

General Activation Process 2

With respect to the lithium ion secondary battery, charging was performed up to 4.10 V at 0.1 mV/s, and then, the voltage was kept for 1 hour at 25° C. Then, discharging was performed down to 3 V at 0.1 mV/s, and then, the voltage was kept for 1 hour at 25° C.

### Comparative Example VII

A lithium ion secondary battery of Comparative Example VII was produced using a method similar to that in Comparative Example V except for using the electrolytic solution of Comparative Production Example 1-1 as the electrolytic solution of the lithium ion secondary battery.

### Comparative Example VIII

A lithium ion secondary battery of Comparative Example VIII was produced using a method similar to that in Example I except for using the electrolytic solution of Comparative Production Example 1-1 as the electrolytic solution of the lithium ion secondary battery.

Table 2 lists the lithium ion secondary batteries of Examples I to V, and Table 3 lists the lithium ion secondary batteries of Comparative Examples I to VIII.

TABLE 2

| | Electrolytic | |
|---|---|---|
| | solution | Outline of activation process |
| Example I | Production | (a) 1 C charging |
| | Example 7-2 | (b) 1 C discharging |
| | | (c) 2 C charging and discharging, |
| | | 29 cycles, 60° C. |
| Example II | Production | (a) 5 C charging |
| | Example 7-2 | (b) 1 C discharging |
| | | (c) 2 C charging and discharging, |
| | | 29 cycles, 60° C. |
| Example III | Production | (a) 10 C charging |
| | Example 7-2 | (b) 1 C discharging |
| | | (c) 2 C charging and discharging, |
| | | 29 cycles, 60° C. |
| Example IV | Production | (a) 5 C charging |
| | Example 7-2 | (d) 80° C., 2 hours |
| Example V | Production | (a) 1 C charging |
| | Example 7-2 | (b) 1 C discharging |
| | | (c) 2 C charging and discharging, |
| | | 29 cycles, 60° C. |
| | | (d) 100° C., 1 hour |

TABLE 3

| | Electrolytic | |
|---|---|---|
| | solution | Outline of activation process |
| Comparative | Production | (a′) 0.1 C [symbol] 0.8 C charging |
| Example I | Example 7-2 | (b) 1 C discharging |
| | | (c) 2 C charging and discharging, |
| | | 29 cycles, 25° C. |
| Comparative | Production | (a′) 0.1 C [symbol] 0.8 C charging, 60° C. |
| Example II | Example 7-2 | (b) 1 C discharging, 60° C. |
| | | (c) 2 C charging and discharging, |
| | | 29 cycles, 60° C. |
| Comparative | Production | (a′) 0.1 C [symbol] 0.8 C charging |
| Example III | Example 7-2 | (b) 1 C discharging |
| | | (c) 2 C charging and discharging, |
| | | 29 cycles, 60° C. |
| Comparative | Production | (a′) 0.1 C [symbol] 0.8 C charging |
| Example IV | Example 7-2 | (d) 60° C., 20 hours |
| Comparative | Production | 0.1 C charging, 0.1 C discharging |
| Example V | Example 7-2 | |
| Comparative | Production | 0.1 mV/sec charging, 0.1 mV/sec |
| Example VI | Example 7-2 | discharging |
| Comparative | Comparative | 0.1 C charging, 0.1 C discharging |
| Example VII | Production | |
| | Example 1-1 | |
| Comparative | Comparative | (a) 1 C charging |
| Example VIII | Production | (b) 1 C discharging |
| | Example 1-1 | (c) 2 C charging and discharging, |
| | | 29 cycles, 60° C. |

(Evaluation Example I: Direct Current Resistance and Capacity Retention Rate)

With respect to the lithium ion secondary batteries of Examples I to V and Comparative Examples I to VIII, the following test was performed to evaluate the direct current resistance and the capacity retention rate.

For each of the lithium ion secondary batteries, the voltage was adjusted to 3.65 V with a constant current at 0.5 C rate at a temperature of −10° C., and then, constant current charging was performed at 3 C rate for 10 seconds. From the current value and the amount of change in voltage before and after this charging, the direct current resistance during charging was calculated according to Ohm's law.

Similarly, for each of the lithium ion secondary batteries, the voltage was adjusted to 3.65 V with a constant current at 0.5 C rate at a temperature of −10° C., and then, constant current discharging was performed at 3 C rate for 2 seconds. From the current value and the amount of change in voltage before and after this discharging, the direct current resistance during discharging was calculated according to Ohm's law.

For each of the lithium ion secondary batteries, a 4.1 V-3.0 V charging and discharging cycle of, with a constant current at 1 C rate at a temperature of 60° C., charging up to 4.1 V and then discharging down to 3.0 V was performed by 200 cycles. The capacity retention rate (%) of each lithium ion secondary battery after 200 cycles was obtained by the following formula. Table 4 shows the results.

Capacity retention rate (%)=(B/A)×100

A: discharge capacity at first charging and discharging cycle

B: discharge capacity at 200-th cycle

TABLE 4

| | Direct current | Direct current | |
|---|---|---|---|
| | resistance | resistance | Capacity |
| | during charging | during discharging | retention rate |
| | (Ω) | (Ω) | (%) |
| Example I | 7.7 | 6.4 | 91 |
| Example II | 7.3 | 6.0 | 92 |
| Example III | 7.2 | 5.8 | 91 |
| Example IV | 7.5 | 6.3 | 91 |
| Example V | 7.4 | 6.2 | 91 |
| Comparative | 10.7 | 9.3 | 91 |
| Example I | | | |
| Comparative | 9.0 | 7.6 | 91 |
| Example II | | | |
| Comparative | 8.4 | 7.2 | 91 |
| Example III | | | |
| Comparative | 8.3 | 7.0 | 91 |
| Example IV | | | |
| Comparative | 14.7 | 12.9 | 91 |
| Example V | | | |
| Comparative | 16.2 | 14.2 | 91 |
| Example VI | | | |
| Comparative | 12.0 | 11.2 | 86 |
| Example VII | | | |
| Comparative | 8.3 | 7.4 | 85 |
| Example VIII | | | |

From the results in Table 4, in the lithium ion secondary batteries of Examples I to V, the resistance during charging and discharging is understood to have been suitably reduced. In addition, the lithium ion secondary batteries of Examples I to V are understood to exhibit a capacity retention rate equivalent to or higher than those of the lithium ion secondary batteries of the Comparative Examples.

### Example VI

A lithium ion secondary battery of Example VI was produced in the following manner using the electrolytic solution of Production Example 8-1.

90 parts by mass of Li_{1.1}Ni_{5/10}Co_{3.5/10}Mn_{1.5/10}O₂ serving as the positive electrode active material, 8 parts by mass of acetylene black serving as the conductive additive, and 2 parts by mass of polyvinylidene fluoride serving as the binding agent were mixed. This mixture was dispersed in a proper amount of N-methyl-2-pyrrolidone to create a slurry. As the positive electrode current collector, an aluminum foil corresponding to JIS A1000 series and having a thickness of 15 μm was prepared. The slurry was applied in a film form on the surface of the aluminum foil by using a doctor blade. The aluminum foil on which the slurry was applied was dried for 20 minutes at 80° C. to remove N-methyl-2-pyrrolidone. Then, the aluminum foil was pressed to obtain a joined object. The obtained joined object was heated and dried in a vacuum dryer for 6 hours at 120° C. to obtain an aluminum foil having a positive electrode active material layer formed thereon. This was used as the positive electrode. The positive electrode active material layer was formed at 6 mg/cm² per unit area of the applied surface of the positive electrode current collector. The density of the positive electrode active material layer was 2.5 g/cm³.

98 parts by mass of spheroidal graphite serving as the negative electrode active material, and 1 part by mass of styrene-butadiene-rubber and 1 part by mass of carboxymethyl cellulose, which both served as the binding agent, were mixed. This mixture was dispersed in a proper amount of ion exchanged water to create a slurry. As the negative electrode current collector, a copper foil having a thickness of 10 μm was prepared. The slurry was applied in a film form on the surface of the copper foil by using a doctor blade. The copper foil on which the slurry was applied was dried to remove water. Then, the copper foil was pressed to obtain a joined object. The obtained joined object was heated and dried in a vacuum dryer for 6 hours at 100° C. to obtain a copper foil having a negative electrode active material layer formed thereon. This was used as the negative electrode. The negative electrode active material layer was formed on the negative electrode current collector at 4 mg/cm² per unit area of the applied surface. The density of the negative electrode active material layer was 1.1 g/cm³.

As the separator, a polypropylene porous film having a thickness of 20 μm was prepared.

An electrode assembly was formed by sandwiching the separator between the positive electrode and the negative electrode. The electrode assembly was covered with a set of two sheets of a laminate film. The laminate film was formed into a bag-like shape by having three sides thereof sealed, and the electrolytic solution of Production Example 8-1 was poured into the laminate film. Four sides were sealed airtight by sealing the remaining one side to obtain a lithium ion secondary battery in which the electrode assembly and the electrolytic solution were sealed.

The following activation process was performed on the obtained lithium ion secondary battery.

Step (a-1)

With respect to the lithium ion secondary battery, charging was performed up to a first voltage 3.0 V at a first rate 0.05 C, and then charging was performed up to a second voltage 4.10 V at a second rate 1.0 C. Then, the second voltage 4.10 V was kept at 25° C. for 1.0 hour.

Step (b)

With respect to the lithium ion secondary battery having been subjected to step (a-2), discharging was performed down to 3 V at a third rate 2 C, and then 3 V was kept for 1 hour at 25° C.

Step (c)

With respect to the lithium ion secondary battery having been subjected to step (b), charging and discharging was performed at a fourth rate 5 C at 60° C., between a third voltage 3.3 V and the second voltage 4.1 V. The lithium ion secondary battery for which the above charging and discharging had been repeated 29 times was used as the lithium ion secondary battery of Example VI.

### Example VII

A lithium ion secondary battery of Example VII was produced using a method similar to that in Example VI except for using the electrolytic solution of Production Example 8-2.

### Example VIII

A lithium ion secondary battery of Example VIII was produced using a method similar to that in Example VI except for using the electrolytic solution of Production Example 8-3.

### Example IX

A lithium ion secondary battery of Example IX was produced using a method similar to that in Example VI except for using the electrolytic solution of Production Example 8-4.

### Example X

A lithium ion secondary battery of Example X was produced using a method similar to that in Example VI except for using the electrolytic solution of Production Example 8-5.

### Comparative Example IX

A lithium ion secondary battery of Example XI was produced using a method similar to that in Example VI except for using the electrolytic solution of Production Example 9-1.

Table 5 lists the lithium ion secondary batteries of Examples VI to X and Comparative Example IX.

TABLE 5

| | Electrolytic | |
|---|---|---|
| | solution | Outline of activation process |
| Example VI | Production | (a) 0.05 C [symbol] 1 C charging |
| | Example 8-1 | (b) 2 C discharging |
| | | (c) 5 C charging and |
| | | discharging, 29 cycles, 60° C. |
| Example VII | Production | (a) 0.05 C [symbol] 1 C charging |
| | Example 8-2 | (b) 2 C discharging |
| | | (c) 5 C charging and |
| | | discharging, 29 cycles, 60° C. |
| Example VIII | Production | (a) 0.05 C [symbol] 1 C charging |
| | Example 8-3 | (b) 2 C discharging |
| | | (c) 5 C charging and |
| | | discharging, 29 cycles, 60° C. |
| Example IX | Production | (a) 0.05 C [symbol] 1 C charging |
| | Example 8-4 | (b) 2 C discharging |
| | | (c) 5 C charging and |
| | | discharging, 29 cycles, 60° C. |
| Example X | Production | (a) 0.05 C [symbol] 1 C charging |
| | Example 8-5 | (b) 2 C discharging |
| | | (c) 5 C charging and |
| | | discharging, 29 cycles, 60° C. |
| Comparative | Production | (a) 0.05 C [symbol] 1 C charging |
| Example IX | Example 9-1 | (b) 2 C discharging |
| | | (c) 5 C charging and |
| | | discharging, 29 cycles, 60° C. |

(Evaluation Example II: Direct Current Resistance and Capacity Retention Rate)

With respect to the lithium ion secondary batteries of Examples VI to X and Comparative Example IX, the same test as in Evaluation Example I was performed to evaluate the direct current resistance and the capacity retention rate. Table 6 shows the results.

TABLE 6

| | Direct current | Direct current | |
|---|---|---|---|
| | resistance | resistance | Capacity |
| | during charging | during discharging | retention rate |
| | (Ω) | (Ω) | (%) |
| Example VI | 6.8 | 5.7 | 93 |
| Example VII | 5.5 | 4.4 | 94 |
| Example VIII | 7.1 | 5.9 | 94 |
| Example IX | 9.5 | 8.8 | 94 |
| Example X | 16.9 | 14.9 | 94 |
| Comparative | 7.5 | 6.3 | 91 |
| Example IX | | | |

From the results in Table 6, the lithium ion secondary batteries of Examples VI to X are understood to exhibit a capacity retention rate equivalent to or higher than that of the lithium ion secondary battery of Comparative Example IX. In this evaluation example, any particular relation was not observed between the capacity retention rate and the direct current resistance values during the charging and discharging.

(Evaluation Example III: Analysis of Coating)

The coatings on the surfaces of the negative electrode active materials of the lithium ion secondary batteries of Examples II and Comparative Example III and Examples VI to X and Comparative Example IX were analyzed by the following method.

Each lithium ion secondary battery was discharged down to 3V. Then, each secondary battery was disassembled, and the negative electrode was taken out. Each negative electrode was washed by performing operation of immersing the negative electrode in dimethyl carbonate for 10 minutes three times, then dried, and used as the analysis target negative electrode. All steps from disassembling each lithium ion secondary battery to transporting each analysis target negative electrode to an analyzer were performed in an Ar gas atmosphere.

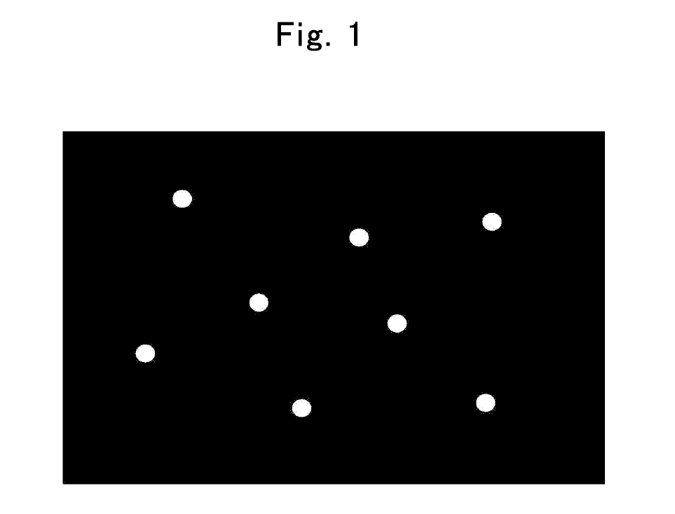

When each of the coatings on the surfaces of the negative electrode active materials was observed with a scanning electron microscope (hereinafter, abbreviated as SEM), white materials were found to be present in the form of dots in an SEM image of each coating, which is mainly in black. FIG. 1 shows a schematic diagram of the SEM image of the coating. In each SEM image, the number of white materials having a long diameter of 30 nm or greater was counted. Table 7 shows the results together with the results of the capacity retention rates of Evaluation Example I and Evaluation Example II.

TABLE 7

| | | Mass % of | | Capac- |
|---|---|---|---|---|
| | | unsaturated | | ity |
| | | cyclic | Number | reten- |
| | | carbonate of | of white | tion |
| | Outline of | electrolytic | materials | rate |
| | activation process | solution | per 1 μm² | (%) |
| Exam- | (a) 5 C charging | Production | 2 | 92 |
| ple II | (b) 1 C discharging | Example 7-2 | | |
| | (c) 2 C charging and | 0% | | |
| | discharging, 29 cycles, | | | |
| | 60° C. | | | |
| Com- | (a′) 0.1 C [symbol] 0.8 C charging | Production | 80.2 | 91 |
| parative | (b) 1 C discharging | Example 7-2 | | |
| Exam- | (c) 2 C charging and | 0% | | |
| ple III | discharging, 29 cycles, | | | |
| | 60° C. | | | |
| Exam- | (a) 0.05 C [symbol] 1 C | Production | 11.8 | 93 |
| ple VI | charging | Example 8-1 | | |
| | (b) 2 C discharging | 0.13% | | |
| | (c) 5 C charging and | | | |
| | discharging, 29 cycles, | | | |
| | 60° C. | | | |
| Exam- | (a) 0.05 C [symbol] 1 C | Production | 1.4 | 94 |
| ple VII | charging | Example 8-2 | | |
| | (b) 2 C discharging | 0.63% | | |
| | (c) 5 C charging and | | | |
| | discharging, 29 cycles, | | | |
| | 60° C. | | | |
| Exam- | (a) 0.05 C [symbol] 1 C | Production | Uncal- | 94 |
| ple VIII | charging | Example 8-3 | culated | |
| | (b) 2 C discharging | 1.3% | | |
| | (c) 5 C charging and | | | |
| | discharging, 29 cycles, | | | |
| | 60° C. | | | |
| Exam- | (a) 0.05 C [symbol] 1C | Production | Uncal- | 94 |
| ple IX | charging | Example 8-4 | culated | |
| | (b) 2 C discharging | 2.5% | | |
| | (c) 5 C charging and | | | |
| | discharging, 29 cycles, | | | |
| | 60° C. | | | |
| Exam- | (a) 0.05 C [symbol] 1 C | Production | 0.6 | 94 |
| ple X | charging | Example 8-5 | | |
| | (b) 2 C discharging | 6.3% | | |
| | (c) 5 C charging and | | | |
| | discharging, 29 cycles, | | | |
| | 60° C. | | | |
| Com- | (a) 0.05 C [symbol] 1 C | Production | 88.4 | 91 |
| parative | charging | Example 9-1 | | |
| Exam- | (b) 2 C discharging | 0% | | |
| ple IX | (c) 5 C charging and | | | |
| | discharging, 29 cycles, | | | |
| | 60° C. | | | |

From the results of Example II and Comparative Example III and the results of Examples VI to X and Comparative Example IX in Table 7, the number of white materials having a long diameter of 30 nm or greater in each SEM image is considered to influence the capacity retention rate. In addition, a lithium ion secondary battery in which the number of materials having a long diameter of 30 nm or greater is less than 80 counts/μm² on the surface of the negative electrode active material is considered to exhibit a better capacity retention rate than the lithium ion secondary batteries of Comparative Example III and Comparative Example IX. The lithium ion secondary battery of the present invention is supported to exhibit an excellent capacity retention rate.

In addition, from the results of Example II and Comparative Example III in Table 7, the number of white materials is found to change when the method of the activation process is different. Specifically, the number of white materials is considered to decrease as the value of the charging rate in step (a) increases.

Furthermore, from the results of Examples VI to X and Comparative Example IX in Table 7, the number of white materials is found to change when the amount of the unsaturated cyclic carbonate contained in the electrolytic solution is different. Specifically, the number of white materials is considered to decrease as the amount of the unsaturated cyclic carbonate contained in the electrolytic solution increases. In addition, for an electrolytic solution containing the unsaturated cyclic carbonate, the number of white materials is considered to decrease even when the value of the charging rate in step (a) is low.

Moreover, as a result of Auger electron spectroscopy analysis, the white materials were found to have a higher F content than the portion of the coating other than the materials. The white materials are considered to be mainly derived from (FSO₂)₂NLi.

From the above respective evaluation results, in the electrolytic solution of the present invention not containing the unsaturated cyclic carbonate, much of (FSO₂)₂NLi is considered to be degraded on the negative electrode together with the linear carbonate under mild charging conditions, thereby forming a coating having a large number of white materials. In addition, in the electrolytic solution of the present invention not containing the unsaturated cyclic carbonate, mainly the linear carbonate is considered to be degraded on the negative electrode under rapid charging conditions, thereby forming a coating having a small number of white materials.

When the electrolytic solution of the present invention containing the unsaturated cyclic carbonate was evaluated by cyclic voltammetry with a graphite-containing electrode as a working electrode, a response current inferred to be derived from degradation of the unsaturated cyclic carbonate was initially observed at a potential at the reducing side.

From the above respective evaluation results, in the electrolytic solution of the present invention containing the unsaturated cyclic carbonate, the unsaturated cyclic carbonate is considered to be degraded on the negative electrode, thereby forming a coating, and (FSO₂)₂NLi is considered to be then degraded on the negative electrode, thereby forming a coating. In the electrolytic solution of the present invention containing the unsaturated cyclic carbonate, the reason why the number of white materials decreased with an increase in mass % of the unsaturated cyclic carbonate is considered to be degradation of (FSO₂)₂NLi being suppressed. On the other hand, in the electrolytic solution of Production Example 9-1 which was used in Comparative Example IX, since no unsaturated cyclic carbonate exists, the number of white materials is considered to increase as a result of much of (FSO₂)₂NLi being degraded.

The coatings on the negative electrode surfaces as analysis targets in the lithium ion secondary batteries of Examples VI to X and Comparative Example IX were analyzed under the following conditions by using X-ray photoelectron spectroscopy.

Apparatus: ULVAC-PHI, Inc., PHI5000 VersaProbe II

X-ray source: monochromatic Al Kα radiation, voltage 15 kV, current 10 mA

Table 8 shows percentages of target elements Li, C, N, O, F, and S obtained through the above analysis with respect to each lithium ion secondary battery.

TABLE 8

| | Mass % of | | | | | | | |
|---|---|---|---|---|---|---|---|---|
| | unsaturated | | | | | | | |
| | cyclic | Li | C | N | O | F | S | N + F + S |
| | carbonate | (%) | (%) | (%) | (%) | (%) | (%) | (%) |
| Example VI | 0.13 | 18.9 | 41.2 | 2.3 | 32.1 | 2.9 | 2.6 | 7.8 |
| Example VII | 0.63 | 19.4 | 41.6 | 1.6 | 32.5 | 3.0 | 1.9 | 6.5 |
| Example | 1.3 | 15.3 | 48.1 | 1.6 | 30.5 | 2.3 | 2.2 | 6.1 |
| VIII | | | | | | | | |
| Example IX | 2.5 | 14.6 | 49.2 | 1.4 | 31.2 | 1.9 | 1.7 | 5.0 |
| Example X | 6.3 | 12.4 | 50.5 | 1.2 | 33.2 | 1.5 | 1.2 | 3.9 |
| Comparative | 0 | 18.7 | 40.1 | 3.1 | 30.7 | 4.2 | 3.2 | 10.5 |
| Example IX | | | | | | | | |

From Table 8, the carbon content of the coating is understood to relatively increase with an increase in mass % of the unsaturated cyclic carbonate. On the other hand, the sum of the contents of N, F, and S derived only from (FSO₂)₂NLi is understood to relatively decrease with an increase in mass % of the unsaturated cyclic carbonate.

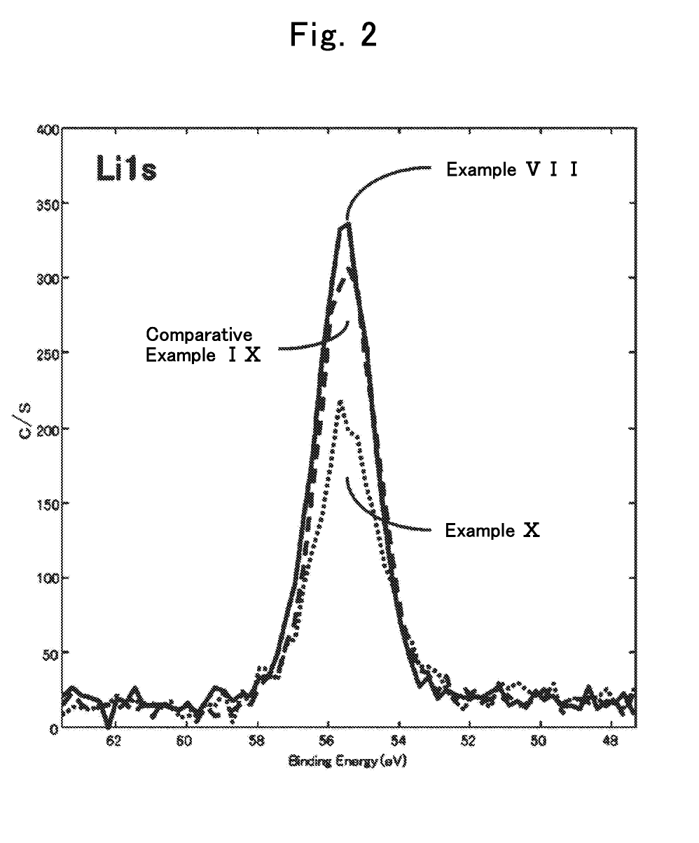

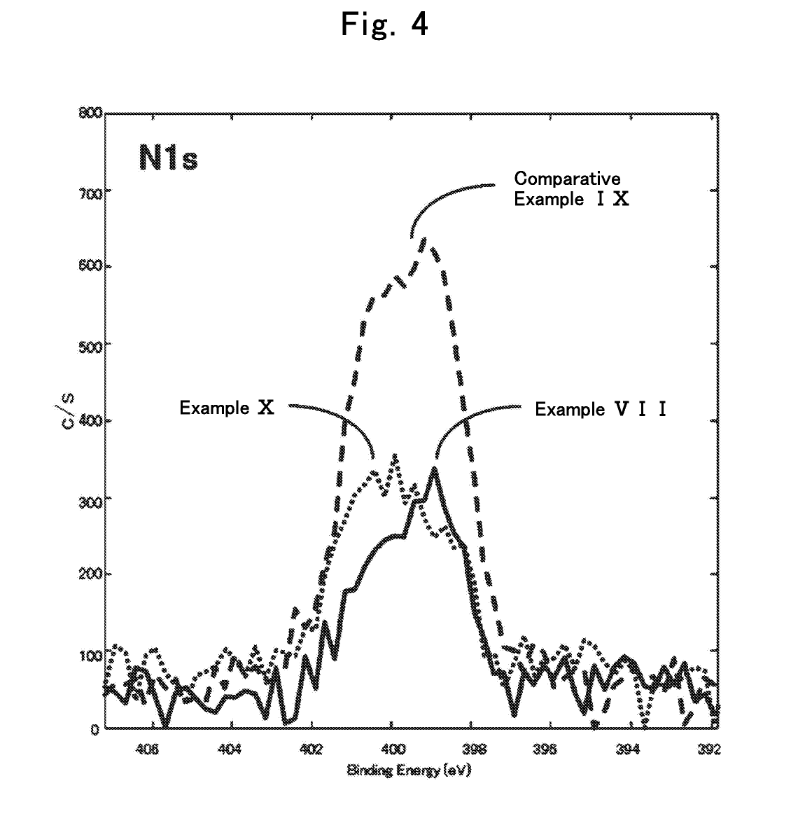

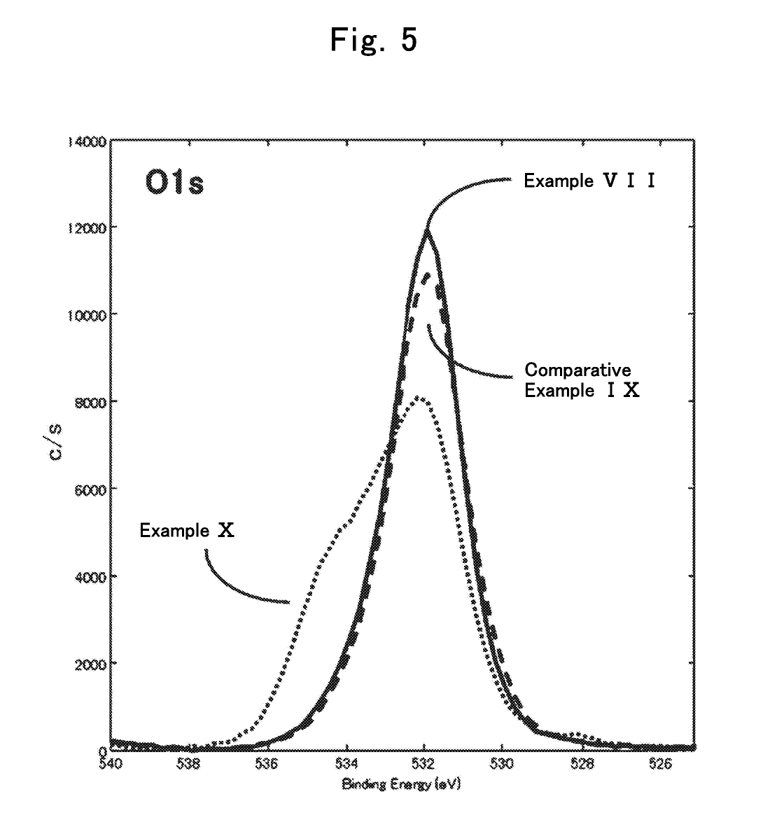

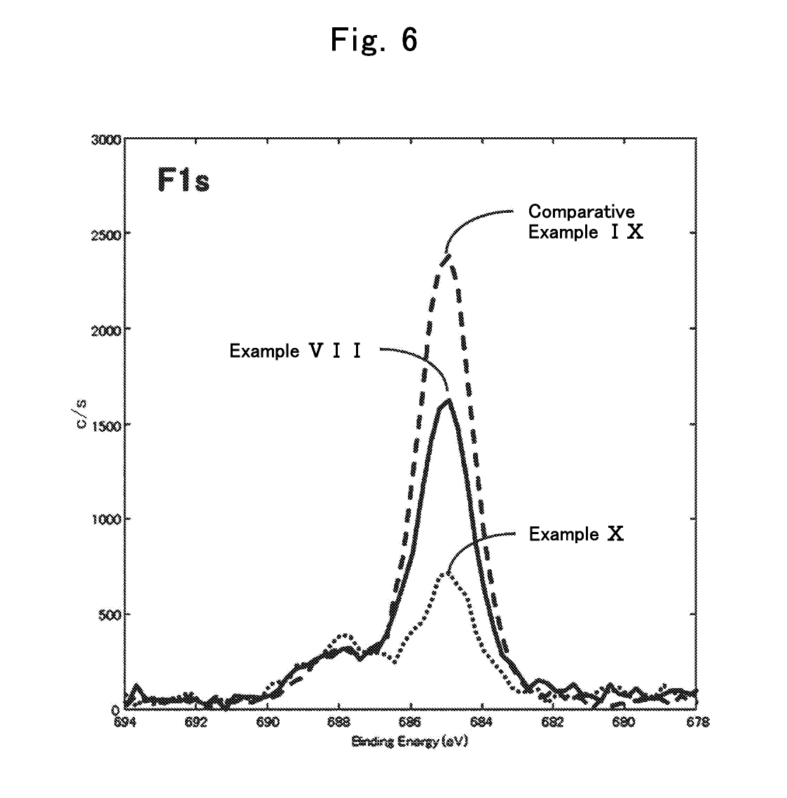

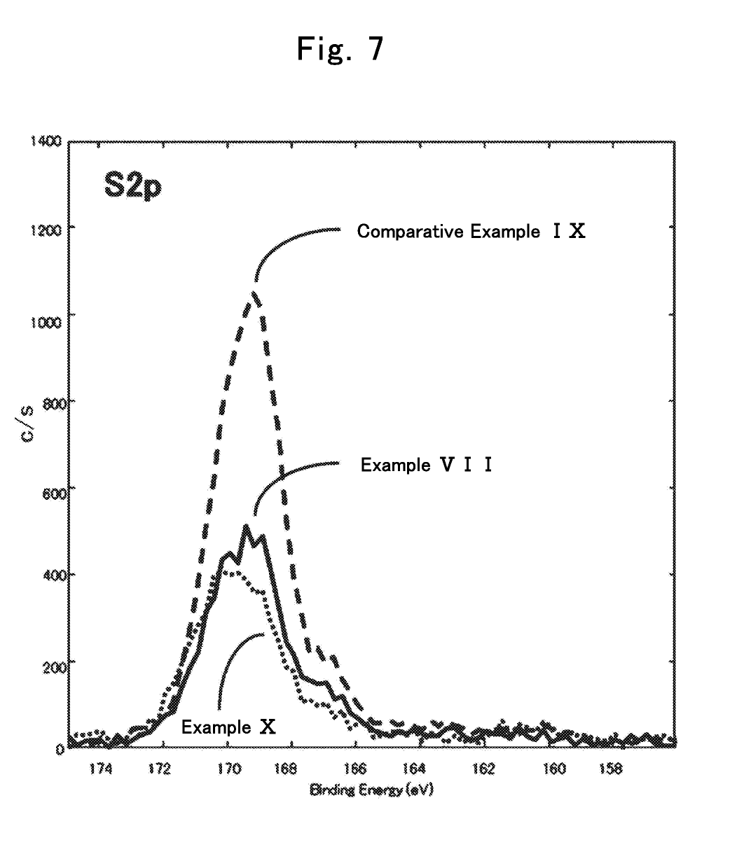

FIGS. 2 to 7 show analysis charts regarding Li, C, N, O, F, and S measured for the lithium ion secondary batteries of Example VII, Example X, and Comparative Example IX.

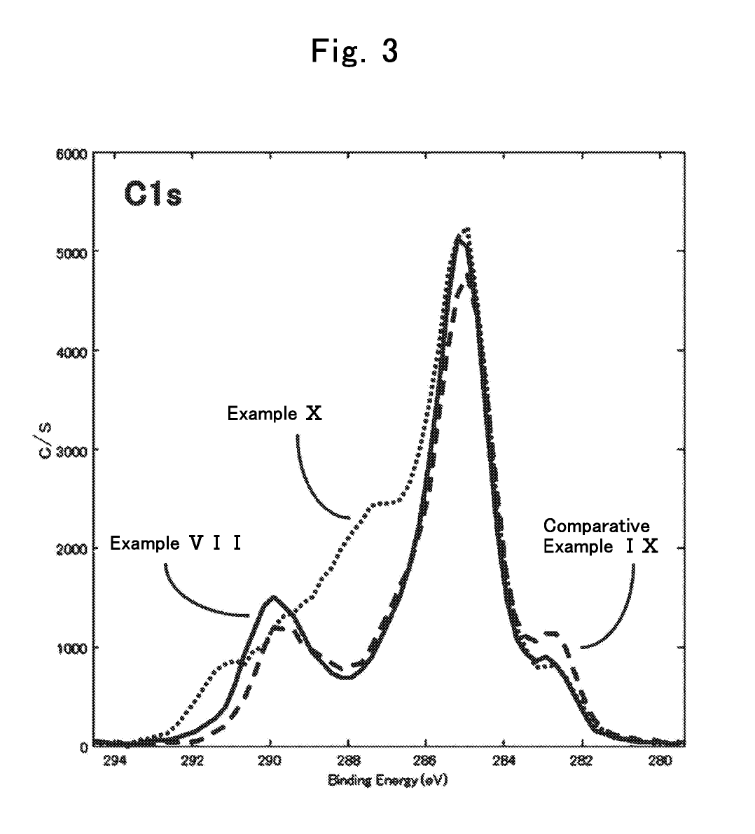

In the analysis chart regarding carbon in FIG. 3, the peak observed at 289.7 eV is considered to be attributed to the chemical structure of CO₃. Here, the CO₃ structure is considered to be capable of coordinating with lithium ions. Accordingly, when a lot of the CO₃ structure exist in the coating, the CO₃ structure suitably assists lithium ions in moving within the coating, and thus the resistance during charging and discharging is considered to be suitably reduced. The reason for the suitable resistance value of the lithium ion secondary battery of Example VII shown in Evaluation Example II is considered as described above.

In the analysis chart of Example X in FIG. 3, a peak considered to be derived from the unsaturated cyclic carbonate was observed at 287.4 eV. 287.4 eV is a value obtained by subtracting 2.3 eV from 289.7 eV. When the results shown in Evaluation Example II are taken into consideration, the resistance of the battery is considered to increase when the peak is higher. Among the electrolytic solutions of the present invention, in the electrolytic solution in which the unsaturated cyclic carbonate excessively exists, some kind of a structure derived from the unsaturated cyclic carbonate is inferred to have excessively formed a coating on the negative electrode surface and have adversely affected the resistance. Furthermore, among the electrolytic solutions of the present invention, in the electrolytic solution in which the unsaturated cyclic carbonate excessively exists, the unsaturated cyclic carbonate is also considered to be oxidatively degraded on the positive electrode, thereby forming a high-resistance coating on the positive electrode surface. The reason for the high resistance value of the lithium ion secondary battery of Example X shown in Evaluation Example II is considered as described above.

When the relationship between the peak at 289.7 eV and the peak at 287.4 eV is considered, the resistance is considered to be lower when the value of (intensity of peak at 289.7 eV)/(intensity of peak at 287.4 eV) is higher. Table 9 shows the values of (intensity of peak at 289.7 eV)/(intensity of peak at 287.4 eV) calculated from the analysis results of the respective lithium ion secondary batteries.

TABLE 9

| | Mass % of | |
|---|---|---|
| | unsaturated | (Intensity of peak at 289.7 eV)/ |
| | cyclic carbonate | (intensity of peak at 287.4 eV) |
| Example VI | 0.13 | 1.33 |
| Example VII | 0.63 | 1.69 |
| Example VIII | 1.3 | 0.88 |
| Example IX | 2.5 | 0.69 |
| Example X | 6.3 | 0.55 |
| Comparative | 0 | 1.21 |
| Example IX | | |

(Reference Evaluation Example 1: Ionic Conductivity)

Ionic conductivities of the electrolytic solutions of Production Examples were measured under the following conditions. Table 10 shows the results. Each blank in the table means that measurement was not performed.

Ionic conductivity measuring conditions

Under an Ar atmosphere, an electrolytic solution was sealed in a glass cell that had a platinum electrode and whose cell constant was known, and impedance thereof was measured at 30° C., 1 kHz. Ionic conductivity was calculated on the basis of the measurement result of the impedance. As a measurement instrument, Solartron 147055BEC (Solartron Analytical) was used.

TABLE 10

| | | | Number of moles | |
|---|---|---|---|---|
| | | | of organic | Ionic |
| | | | solvent/ | conduc- |
| | Lithium | Organic | number of moles | tivity |
| | salt | solvent | of lithium salt | (mS/cm) |
| Production | LiFSA | DMC | 1.6 | 2.6 |
| Example 1-1 | | | | |
| Production | LiFSA | DMC | 2 | 3.2 |
| Example 1-2 | | | | |
| Production | LiFSA | DMC | 3 | 5.9 |
| Example 1-3 | | | | |
| Production | LiFSA | DMC | 3.5 | |
| Example 1-4 | | | | |
| Production | LiFSA | DMC | 4 | |
| Example 1-5 | | | | |
| Production | LiFSA | DMC | 5 | 8.7 |
| Example 1-6 | | | | |
| Production | LiFSA | DMC | 11 | 6.8 |
| Example 1-7 | | | | |
| Production | LiFSA | DMC and DEC | 3 | |
| Example 2-1 | | mole ratio 9:1 | | |
| Production | LiFSA | DMC and DEC | 3 | |
| Example 2-2 | | mole ratio 7:1 | | |
| Production | LiFSA | DMC and DEC | 4 | |
| Example 2-3 | | mole ratio 9:1 | | |
| Production | LiFSA | DMC and PC | 3 | 4.7 |
| Example 3 | | mole ratio 7:1 | | |
| Production | LiFSA | DMC and EC | 3.1 | 4.8 |
| Example 4 | | mole ratio 7:1 | | |
| Production | LiFSA | EMC | 3.5 | |
| Example 5 | | | | |
| Production | LiFSA | DEC | 3.5 | |
| Example 6 | | | | |
| Production | LiFSA | DMC and EMC | 3 | |
| Example 7-1 | | mole ratio 9:1 | | |
| Production | LiFSA | DMC and EMC | 3.6 | |
| Example 7-2 | | mole ratio 9:1 | | |
| Production | LiFSA | DMC and EMC | 4 | |
| Example 9-1 | | mole ratio 9:1 | | |

The electrolytic solutions of all Production Examples exhibited suitable ionic conductivity. Thus, the electrolytic solution of the present invention is understood to suitably function as an electrolytic solution for various power storage devices. In addition, from the results of the electrolytic solutions of Production Example 1-3, Production Example 3, and Production Example 4, the ionic conductivity is understood to decrease when the cyclic carbonate is used as a part of the organic solvent.

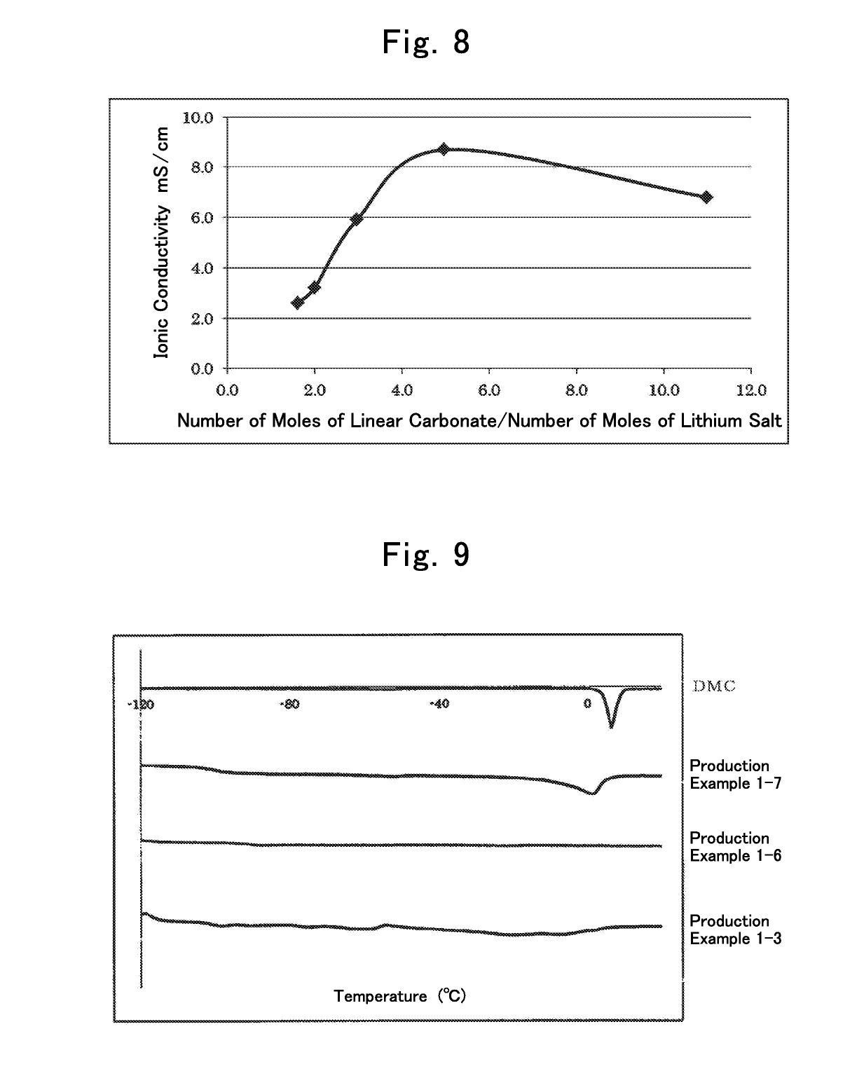

Here, with respect to the electrolytic solutions of Production Example 1-1, Production Example 1-2, Production Example 1-3, Production Example 1-6, and Production Example 1-7, in all of which the linear carbonate is DMC, the relationship between the ionic conductivity and the mole ratio of linear carbonate/lithium salt is shown in a graph. FIG. 8 shows the graph.

FIG. 8 suggests that the local maximum of the ionic conductivity is present at a mole ratio of linear carbonate/lithium salt within a range of 3 to 6.

(Reference Evaluation Example 2: Density)

The densities at 20° C. of the electrolytic solutions of Production Examples were measured. Table 11 shows the results. Each blank in the table means that measurement was not performed.

TABLE 11

| | | | Number of moles of | |
|---|---|---|---|---|
| | | | organic solvent/ | |
| | Lithium | Organic | number of moles of | Density |
| | salt | solvent | lithium salt | (g/cm³) |
| Production | LiFSA | DMC | 1.6 | 1.48 |
| Example 1-1 | | | | |
| Production | LiFSA | DMC | 2 | 1.44 |
| Example 1-2 | | | | |
| Production | LiFSA | DMC | 3 | 1.38 |
| Example 1-3 | | | | |
| Production | LiFSA | DMC | 3.5 | 1.35 |
| Example 1-4 | | | | |
| Production | LiFSA | DMC | 4 | 1.31 |
| Example 1-5 | | | | |
| Production | LiFSA | DMC | 5 | 1.27 |
| Example 1-6 | | | | |
| Production | LiFSA | DMC | 11 | 1.16 |
| Example 1-7 | | | | |
| Production | LiFSA | DMC and DEC | 3 | 1.33 |
| Example 2-1 | | mole ratio 9:1 | | |
| Production | LiFSA | DMC and DEC | 3 | |
| Example 2-2 | | mole ratio 7:1 | | |
| Production | LiFSA | DMC and DEC | 4 | |
| Example 2-3 | | mole ratio 9:1 | | |
| Production | LiFSA | DMC and PC | 3 | 1.38 |
| Example 3 | | mole ratio 7:1 | | |
| Production | LiFSA | DMC and EC | 3.1 | 1.39 |
| Example 4 | | mole ratio 7:1 | | |
| Production | LiFSA | EMC | 3.5 | |
| Example 5 | | | | |
| Production | LiFSA | DEC | 3.5 | 1.20 |
| Example 6 | | | | |
| Production | LiFSA | DMC and EMC | 3 | 1.34 |
| Example 7-1 | | mole ratio 9:1 | | |
| Production | LiFSA | DMC and EMC | 3.6 | 1.32 |
| Example 7-2 | | mole ratio 9:1 | | |
| Production | LiFSA | DMC and EMC | 4 | |
| Example 9-1 | | mole ratio 9:1 | | |

(Reference Evaluation Example 3: Viscosity)

The viscosities of the electrolytic solutions of Production Examples were measured under the following conditions. Table 12 shows the results. Each blank in the table means that measurement was not performed.

Viscosity Measuring Conditions

In an Ar atmosphere, an electrolytic solution was sealed in a test cell, and viscosity was measured under a condition of 30° C. by using a falling ball viscometer (Lovis 2000 M manufactured by Anton Paar GmbH).

TABLE 12

| | | | Number of moles | |
|---|---|---|---|---|
| | | | of organic | |
| | | | solvent/ | |
| | Lithium | Organic | number of moles | Viscosity |
| | salt | solvent | of lithium salt | (mPa · s) |
| Production | LiFSA | DMC | 1.6 | 105.5 |
| Example 1-1 | | | | |
| Production | LiFSA | DMC | 2 | 50.9 |
| Example 1-2 | | | | |
| Production | LiFSA | DMC | 3 | 17.6 |
| Example 1-3 | | | | |
| Production | LiFSA | DMC | 3.5 | |
| Example 1-4 | | | | |
| Production | LiFSA | DMC | 4 | |
| Example 1-5 | | | | |
| Production | LiFSA | DMC | 5 | 5.4 |
| Example 1-6 | | | | |
| Production | LiFSA | DMC | 11 | 1.7 |
| Example 1-7 | | | | |
| Production | LiFSA | DMC and DEC | 3 | |
| Example 2-1 | | mole ratio 9:1 | | |
| Production | LiFSA | DMC and DEC | 3 | |
| Example 2-2 | | mole ratio 7:1 | | |
| Production | LiFSA | DMC and DEC | 4 | |
| Example 2-3 | | mole ratio 9:1 | | |
| Production | LiFSA | DMC and PC | 3 | 17.8 |
| Example 3 | | mole ratio 7:1 | | |
| Production | LiFSA | DMC and EC | 3.1 | 18.0 |
| Example 4 | | mole ratio 7:1 | | |
| Production | LiFSA | EMC | 3.5 | |
| Example 5 | | | | |
| Production | LiFSA | DEC | 3.5 | |
| Example 6 | | | | |
| Production | LiFSA | DMC and EMC | 3 | |
| Example 7-1 | | mole ratio 9:1 | | |
| Production | LiFSA | DMC and EMC | 3.6 | |
| Example 7-2 | | mole ratio 9:1 | | |
| Production | LiFSA | DMC and EMC | 4 | |
| Example 9-1 | | mole ratio 9:1 | | |

When the viscosity of an electrolytic solution is excessively low, if a power storage device including such an electrolytic solution is broken, leakage of a large amount of the electrolytic solution is a concern. On the other hand, when the viscosity of an electrolytic solution is excessively high, a decrease in ion conductive property of the electrolytic solution is a concern, and a decrease in productivity becomes a concern due to inferior impregnating ability of the electrolytic solution into the electrode, the separator, etc., during manufacture of the power storage device. In the electrolytic solutions in which the mole ratio of linear carbonate/lithium salt is approximately 3 to 6, the viscosity is understood to be neither excessively low nor excessively high.

In addition, from the results of the electrolytic solutions of Production Example 1-3, Production Example 3, and Production Example 4, the viscosity is understood to increase when the cyclic carbonate is used as a part of the organic solvent.

(Reference Evaluation Example 4: Low Temperature Storage Test)

Each of the electrolytic solutions of Production Example 1-2, Production Example 1-3, Production Example 1-5, Production Example 1-6, and Production Example 1-7 was placed in a container, and the container was filled with inert gas and sealed. These containers were stored in a freezer at −20° C. for 2 days. Each electrolytic solution having been stored was observed. Table 13 shows the results.

TABLE 13

| | | | | State of |
|---|---|---|---|---|
| | | | Linear | electrolytic |
| | Lithium | Organic | carbonate/ | solution |
| | salt | solvent | lithium salt | after storage |
| Production | LiFSA | DMC | 2 | No change |
| Example 1-2 | | | | |
| Production | LiFSA | DMC | 3 | No change |
| Example 1-3 | | | | |
| Production | LiFSA | DMC | 4 | No change |
| Example 1-5 | | | | |
| Production | LiFSA | DMC | 5 | Solidified |
| Example 1-6 | | | | |
| Production | LiFSA | DMC | 11 | Solidified |
| Example 1-7 | | | | |

The electrolytic solutions are understood to be easily solidified at a low temperature when the value of the mole ratio of linear carbonate/lithium salt increases, that is, becomes closer to conventional values. The electrolytic solution of Production Example 1-6 was solidified as a result of having been stored at −20° C. for 2 days, but is considered to be less likely to be solidified when compared to the electrolytic solution of Production Example 1-7, which is an electrolytic solution having a conventional concentration.

(Reference Evaluation Example 5: DSC Measurement)

The electrolytic solution of Production Example 1-3 was placed in a stainless steel pan, and the pan was sealed. Using an empty sealed pan as a control, differential scanning calorimetry analysis was performed in a nitrogen atmosphere using the following temperature program. As a differential scanning calorimeter, Rigaku DSC8230 was used.

Temperature program: Increase the temperature from room temperature to 70° C. at 5 ° C./min, and keep the temperature for 10 minutes->decrease the temperature to −120° C. at 5° C./min, and keep the temperature for 10 minutes->increase the temperature to 70° C. at 3° C./min.

The DSC curve obtained when the temperature was increased from −120° C. to 70° C. at 3° C./min was observed. Also, with respect to the electrolytic solution of Production Example 1-6, the electrolytic solution of Production Example 1-7, and DMC, differential scanning calorimetry analysis was performed in a similar manner. FIG. 9 shows the overlaid respective DSC curves.

In each of the DSC curves of DMC and the electrolytic solution of Production Example 1-7 in FIG. 9, a melting peak was observed near 0 to 10° C. On the other hand, in each of the DSC curves of Production Example 1-3 and Production Example 1-6, no clear melting peak was observed. This result suggests that the electrolytic solutions in which the mole ratio of linear carbonate/lithium salt is approximately 3 to 6 are less likely to be solidified or crystallized in a low temperature environment. Thus, suitable ones of the electrolytic solutions of the present invention are speculated to suppress to some extent a decrease in ionic conductivity in a low temperature environment. With respect to the electrolytic solutions of the present invention, when usage in a low temperature environment is important, not only DMC having a melting point near 4° C. but also EMC having a melting point near −55° C. and DEC having a melting point near −43° C. are preferably used in combination as the linear carbonate.

(Reference Evaluation Example 6: DSC Measurement <2>)

The electrolytic solution of Production Example 2-3 was placed in a pan formed from aluminum, and the pan was sealed. Using an empty sealed pan as a control, differential scanning calorimetry analysis was performed in a nitrogen atmosphere using the following temperature program. As a differential scanning calorimeter, DSC Q2000 (manufactured by TA Instruments) was used.

Temperature program: Decrease the temperature from room temperature to −75° C. at 5° C./min, and keep the temperature for 10 minutes->increase the temperature to 70° C. at 5° C./min.

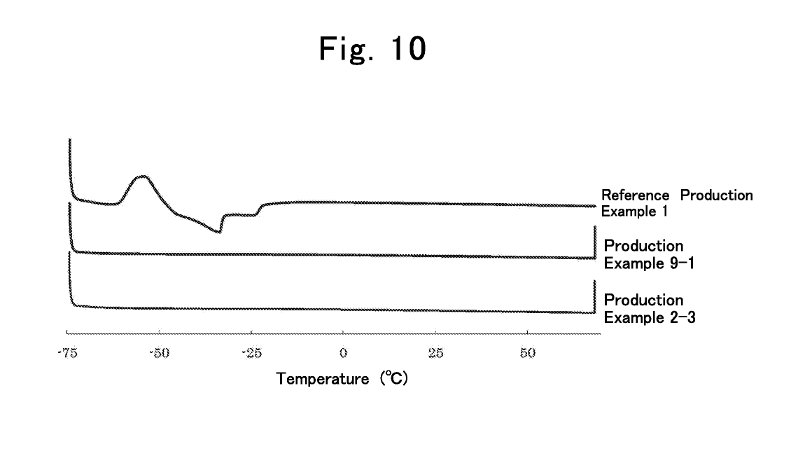

The DSC curve obtained when the temperature was increased from −75° C. to 70° C. at 5° C./min was observed. Also with respect to the electrolytic solution of Production Example 9-1 and an electrolytic solution of Reference Production Example 1 described below, differential scanning calorimetry analysis was performed in a similar manner. FIG. 10 shows the overlaid respective DSC curves.

### Reference Production Example 1

LiPF₆ serving as the electrolyte was dissolved in a mixed solvent obtained by mixing ethylene carbonate serving as the cyclic carbonate and ethyl methyl carbonate and dimethyl carbonate serving as the linear carbonate at a volume ratio of 3:3:4, whereby an electrolytic solution of Reference Production Example 1 containing LiPF₆ at a concentration of 1.0 mol/L was produced. In the electrolytic solution of Reference Production Example 1, the organic solvent is contained at a mole ratio of approximately 10 relative to the electrolyte.

With reference to FIG. 10, in the DSC curve of the electrolytic solution of Reference Production Example 1, an endothermic peak estimated to be derived from the melting point was observed near −50 to −20° C. On the other hand, no endothermic peak was observed in the DSC curves of Production Example 2-3 and Production Example 9-1. The electrolytic solution of the present invention using the linear carbonate in combination is considered to be less likely to be solidified or crystallized in a low temperature environment. Therefore, secondary batteries using the electrolytic solution of the present invention are speculated to suitably act even under a significantly low temperature condition.

1. A lithium ion secondary battery comprising: an electrolytic solution containing (FSO₂)₂NLi and a linear carbonate represented by general formula (A) below; and a negative electrode having a negative electrode active material, wherein
materials having a long diameter of 30 nm or greater exist on a surface of the negative electrode active material in a range of not less than 0 counts/μm² and less than 80 counts/μm²,
R²⁰OCOOR²¹ general formula (A)
(R²⁰ and R²¹ are each independently selected from CₙHₐF_{b}Cl_{c}Br_{d}Iₑ that is a linear alkyl, or CₘH_{f}F_{g}ClₕBrᵢIⱼ that includes a cyclic alkyl in the chemical structure thereof. “n” is an integer not smaller than 1, “m” is an integer not smaller than 3, and “a”, “b”, “c”, “d”, “e”, “f”, “g”, “h”, “i”, and “j” are each independently an integer not smaller than 0, and satisfy 2n+1=a+b+c+d+e and 2m−1=f+g+h+i+j.).

2. The lithium ion secondary battery according to claim 1, wherein the negative electrode contains Li, S, F, O, N, and C.

3. The lithium ion secondary battery according to claim 1, wherein
the materials contain F.

4. The lithium ion secondary battery according to claim 1, wherein
a value of (a concentration of F in the material)/(a concentration of F in the surface of the negative electrode active material other than the material) exceeds 1.

5. The lithium ion secondary battery according to claim 1, wherein
the negative electrode has a CO₃ bond.

6. The lithium ion secondary battery according to claim 1, wherein
when binding energy of carbon in the surface of the negative electrode active material is measured by using X-ray photoelectron spectroscopy, a value of (a signal value of a peak having a peak top at 290±2 eV)/(a signal value at a location of an eV value obtained by subtracting 2.3 eV from an eV value of the peak) is not less than 0.7.

7. The lithium ion secondary battery according to claim 1, wherein
the electrolytic solution contains (FSO₂)₂NLi at a concentration of 1.1 to 3.8 mol/L.

8. The lithium ion secondary battery according to claim 1, wherein
the electrolytic solution contains (FSO₂)₂NLi at a concentration of 2.0 to 3.0 mol/L.

9. The lithium ion secondary battery according to claim 1, wherein
the linear carbonate is contained by not less than 70 mass % or 70 mole % relative to an entire organic solvent contained in the electrolytic solution.

10. The lithium ion secondary battery according to claim 1, wherein
the electrolytic solution contains an unsaturated cyclic carbonate.

11. A method for producing the lithium ion secondary battery according to claim 1,
the method comprising forming materials having a long diameter of 30 nm or greater on a surface of a negative electrode active material by performing, on a lithium ion secondary battery including the electrolytic solution according to claim 1, a negative electrode, and a positive electrode, an activation process including step (a), step (b), and step (c) below, or step (a) and step (d) below,
(a) step of performing charging to a second voltage V₂ in step (a-1) or step (a-2) below,
(a-1) step of performing charging at a first rate C₁ to a first voltage V₁ and then performing charging at a second rate C₂ to the second voltage V₂ (V₁<V₂, C₁<C₂, C₂ is not less than 1 C),
(a-2) step of performing charging at a constant charging rate Cₐ₋₂ of 1 C or higher to the second voltage V₂,
(b) step of discharging the lithium ion secondary battery having been subjected to step (a), at a third rate C₃ to a third voltage V₃ or lower,
(c) step of performing charging and discharging at a fourth rate C₄ between the third voltage V₃ and the second voltage V₂, and
(d) step of keeping the temperature of the lithium ion secondary battery in a range of 40 to 120° C.

12. A method for producing the lithium ion secondary battery according to claim 10,
the method comprising forming materials having a long diameter of 30 nm or greater on a surface of a negative electrode active material by performing, on a lithium ion secondary battery including the electrolytic solution according to claim 10, a negative electrode, and a positive electrode, an activation process including step (a), step (b), and step (c) below, or step (a) and step (d) below,
(a) step of performing charging to a second voltage V₂ in step (a-3) or step (a-4) below,
(a-3) step of performing charging at a first rate C₁ to a first voltage V₁ and then performing charging at a second rate C₂ to the second voltage V₂ (V₁<V₂, C₁<C₂),
(a-4) step of performing charging at a constant charging rate Cₐ₋₂ of 0.05C or higher to the second voltage V₂,
(b) step of discharging the lithium ion secondary battery having been subjected to step (a), at a third rate C₃ to a third voltage V₃ or lower,
(c) step of performing charging and discharging at a fourth rate C₄ between the third voltage V₃ and the second voltage V₂, and
(d) step of keeping the temperature of the lithium ion secondary battery in a range of 40 to 120° C.
